(19) United States
(12) Patent Application Publication
(10) Pub. No.: US 2019/0180307 A1
(43) Pub. Date: Jun. 13, 2019

(54) SYSTEMS AND METHODS FOR REWARDING USERS OF A SOCIAL NETWORK

(71) Applicant: UnVig, LLC, Los Angeles, CA (US)

(72) Inventors: Brian Edward Cohen, Clayton, MO (US); Nathan M. Shaw, Los Angeles, CA (US); Andrew Dale Sharp, Los Angeles, CA (US)

(73) Assignee: UnVig, LLC, Los Angeles, CA (US)

(21) Appl. No.: 15/836,783

(22) Filed: Dec. 8, 2017

(51) Int. Cl. G06Q 30/02; G06Q 50/00; G07C 13/00

(52) U.S. Cl. CPC G06Q 30/0215; G06Q 50/01; G06Q 20/065; G06Q 2220/00; G07C 13/00

(57) ABSTRACT

Systems and methods for rewarding users of a social network are disclosed. In embodiments, a social networking system receives a first user's prediction regarding an event, series of events, or portion of an event, as well as the first user's reasoning supporting the prediction. In certain embodiments, the social networking system then receives feedback—for example, in the form of a vote of approval—from one or more users regarding the information received from the first user. According to some embodiments, reward amounts for the first user and the feedback-providing users are then calculated based on at least the feedback and the outcome of the event, series of events, or portion of an event, the first user's prediction is about.

### FIELD OF THE INVENTION

At least some of the embodiments described herein relate generally to social networking systems.

### BACKGROUND

### Social Networks

Social networking services are online platforms that allow people to interact with other individuals that share similar interests, backgrounds, or real-life connections. Such services rely heavily on user-generated content. However, these services have historically not provided rewards to users. Rather, these services have themselves absorbed the value of user activity. Some of the most popular social networking services include Facebook, Instagram, Reddit, and Twitter.

Notably, the recently-released social networking service Steem has broken ranks with its predecessor social networking services by allowing its users to earn cryptocurrency rewards for their contributions to the network. For example, Steem rewards users (1) for generating content that other users vote for, and (2) for voting for content that other users on the network vote for later (a process known as “curating”). Steem's cryptocurrency reward system is enabled by a blockchain that issues a pre-defined amount of rewards (tokens) at set intervals, and distributes those rewards to users based, in part, on their respective activity on the network. Notably, these rewards have acquired monetary value and are traded on exchanges.

Unfortunately, Steem's method of rewarding users incentivizes users to increase their opportunities to win valuable rewards by creating and voting for a large quantity of content. This incentive causes users to not only create and vote for high-quality content, but also low-quality content that contributes little value to the network's other users because they do not want to view or engage with it. Such low-quality content is sometimes referred to herein as “waste.” Filling a social network with waste makes it difficult for users to find content that appeals to them, and creates unnecessary costs, such as those related to processing and storing waste. Moreover, in a social network that has a finite supply of rewards, awarding users that create and vote for waste means fewer rewards are available for users that create and curate high-quality content. As a result, the valuable users are not as well rewarded as they could be, and are therefore less incentivized than they could be to continue creating and curating high-quality content for the network.

In a social network that awards users with rewards of value, systems and methods that incentivize the creation of high-quality content, while lessening or eliminating the incentive to create low-quality content, are beneficial. Moreover, when the social network's rewards are of finite supply, such systems and methods are helpful for ensuring that users who create and/or curate high-quality content are better rewarded than they would have been if more rewards were directed to users who create and/or curate waste. By redirecting what would have been waste-related rewards to users associated with high-quality content, either through creating such content or curating it, users are encouraged to create and curate more high-quality content for the network.

### Sportsbooks, Brokerages, and Prediction Markets

People speculate on their predicted outcomes of future events in many ways. For example, people: wager on sports in order to speculate on team and/or player performance; wager on political contests in order to speculate on candidate performance in an election; buy and short stocks, and trade stock options and other forms of stock derivatives, in order to speculate on the future price of a company's shares; and purchase and short currency (including fiat currency and cryptocurrency), and trade currency derivatives, in order to speculate on a currency's value relative to other currencies' values in the future. Sportsbooks (often illegally) offer people the opportunity to wager on, for example, sports and political contests, while brokerages offer people the opportunity to speculate on stock, bond, and/or currency values. More generally, prediction markets are exchange-traded markets that offer people the opportunity to potentially speculate on all of these things, depending on what bets users are willing to take. Sportsbooks, brokerages, and prediction markets each identify the potential return on investment (“ROI”) one will have if they choose to speculate on a particular event; this potential ROI can reflect the market's expected probability of the event occurring, or in the case of a sportsbook, the sportsbook's expected probability of the event occurring.

Vast sums of money are involved with the types of speculation mentioned above. For example, it was estimated in 2014 that $400 billion is illegally sports bet in the United States alone each year. That number is dwarfed by the amount of money speculated worldwide on stocks, bonds, and currencies, with the United States stock market on its own being worth over $25 trillion.

In light of the magnitude of money at stake on the various types of predictions people make, systems and methods that incentivize subject matter experts to share their insights and help people make better predictions are particularly valuable. Moreover, people seeking expert advice about how to correctly predict the outcomes of speculative activities, such as gambling and investing, may not have their interests aligned with the alleged experts offering advice. In particular, individuals claiming to be experts may only be seeking payment for their advice, but without actually having a stake in whether their prediction ends up being accurate. By conditioning the reward an alleged expert receives on their prediction being correct, the incentives of people seeking advice align with the incentive of the alleged expert, which in turn increases the probability the alleged expert is offering the best advice they can. Systems and methods that align such incentives are therefore valuable.

In addition, studies have shown that people feel the pain of loss more acutely than they feel the pleasure of gain, with some studies demonstrating that the pain of losing is psychologically twice as powerful as the pleasure of gaining. As a result, people have a tendency to prefer avoiding losses to making equivalent gains. This concept—known as loss aversion—can prevent people from speculating on certain events. Accordingly, even if a person is an expert and has valuable insights on a particular event, loss aversion may prevent that person from profiting from those insights. Systems and methods that allow people to profit from their knowledge without risking anything are therefore valuable. Moreover, a person's failure to monetarily speculate on an event they are an expert on means their insights are not accounted for in the market's expected probability of the event occurring. Systems and methods that provide the marketplace with more robust information are also therefore valuable.

Systems and methods which allow people to feel as though they are gambling, but while also complying with at least U.S. gambling laws, are also valuable as they provide a legal gambling substitute. Examples of such systems and methods are ones that allow people to be rewarded for predicting the outcome of a sporting event, but without actually risking anything, and in a way in which the amount awarded varies based on the outcome of the event.

### SUMMARY

Some embodiments of the inventive subject matter are social networking systems that reward a user for sharing their prediction regarding an event, series of events, or portion of an event. In certain of these embodiments, the user also shares their reasoning supporting the prediction. Feedback is then received from other users regarding the prediction. In some embodiments in which supporting reasoning is also provided, the feedback may relate to both the prediction and the supporting reasoning. In certain embodiments, users may only provide feedback in the form of a vote of approval, or choose not to provide feedback. In some embodiments, a user providing positive feedback regarding a prediction is considered to be making the same prediction. A reward amount for the predicting user is calculated based at least on the feedback provided by the other users, as well as the outcome of the relevant event, series of events, or portion of an event that is the subject of the prediction. In some embodiments, reward amounts for the feedback-providing users are also calculated based at least on the feedback and outcome.

In some embodiments, a voting power metric is calculated for each user and is used to determine the effect each user's feedback has on the amount of rewards that are given. In certain embodiments, a voting power metric is calculated using at least a user's prior track record for predicting events, as well as the amount of rewards the user owns.

In certain embodiments, users may be rewarded for accomplishing goals related to predicting the outcomes of multiple events, series of events, or portions of events. For example, in some of these embodiments, users may be rewarded for providing positive feedback regarding multiple predictions of other users in a row.

### BRIEF DESCRIPTION OF THE DRAWINGS

FIG. 1 is a block diagram illustrating a system environment for a social networking system, in accordance with some embodiments of the invention.

FIG. 2 is an example block diagram of an architecture of a social networking system, in accordance with some embodiments of the invention.

FIG. 3 is a block diagram of a process for determining one or more voting power metrics for users of a social networking system, according to some embodiments.

FIG. 4 is a flow chart of a method for determining a voting power metric maintained by a social networking system, in accordance with some embodiments.

FIG. 5 is a block diagram illustrating a method for determining one or more reward amounts to award one or more users of a social networking system, according to some embodiments.

FIG. 6 is a flow chart illustrating a method for rewarding one or more users in a social networking system, in accordance with some embodiments.

FIG. 7 is a block diagram illustrating a method for determining one or more reward amounts to award one or more users of a social networking system, according to some embodiments.

FIG. 8 is a flow chart illustrating a method for rewarding one or more users in a social networking system, in accordance with some embodiments.

FIG. 9 is a flow chart illustrating a method for rewarding one or more users in a social networking system, in accordance with some embodiments.

FIG. 10, which consists of FIGS. 10A and 10B, is a flow chart illustrating a method for rewarding one or more users in a social networking system, in accordance with some embodiments. Each of FIGS. 10A and 10B illustrate a sequential portion of the overall method disclosed in FIG. 10.

FIG. 11, which consists of FIGS. 11A, 11B, and 11C, is a flow chart illustrating a method for rewarding one or more users in a social networking system, in accordance with some embodiments. Each of FIGS. 11A, 11B, and 11C, illustrate a sequential portion of the overall method disclosed in FIG. 11.

### DETAILED DESCRIPTION

Methods, systems, and computer-readable storage mediums storing instructions are described herein for rewarding users of a social networking system. In the following description, for purposes of explanation, numerous specific details are set forth in order to provide a thorough understanding of example embodiments. It will be evident, however, to one skilled in the art that the present technology may be practiced without these specific details.

Certain embodiments of the present invention comprise calculating a reward based at least on the accuracy of a user's prediction of the outcome of an event, series of events, or portion of an event. These embodiments are beneficial for a variety of reasons. First, a social network that rewards a user at least in part by incorporating such an objective component removes at least some incentive for users to create and/or curate waste. For example, users that compose and/or curate a large number of posts regarding subjects they are not knowledgeable about will earn fewer rewards than they would have otherwise due to the difficulty of predicting the outcomes of events, series of events, or portions of events the users know little to nothing about. In addition, when an author's reward is calculated based on both the predictive accuracy referenced above, as well as feedback from other users, authors that randomly compose a large number of posts will earn fewer rewards as they will have a poor track record for making predictions, and other users will see this poor track record and be less willing to support the author's posts in the future.

Beyond the above, in a social network that has a pre-determined supply of rewards to award users, constraining the amount of rewards that are given to users that compose and/or curate waste means more rewards are available for users making high quality contributions to the social network. The availability of these additional rewards creates a stronger incentive for those users to continue making high quality contributions, as well as a stronger incentive for new users to join the network and make high quality contributions themselves. As the network is populated with more and more high quality content, even more users will flock to the network to review and interact with such content.

Incentivizing high quality contributions with embodiments described herein also encourages experts at predicting outcomes to share their insights as they have an increased probability of receiving rewards relative to lay users. Moreover, certain of these embodiments also align incentives between people providing alleged expertise and the people seeking expertise as the amount of rewards an alleged expert receives is impacted by whether the alleged expert provides accurate advice.

Some embodiments of the present invention include a method for rewarding users of a social network, comprising: receiving a user's predicted outcome of an event, series of events, or portion of an event; receiving the user's reasoning supporting the prediction; receiving feedback from other users; and calculating one or more rewards based on both the feedback and the accuracy of the prediction. These embodiments are beneficial at least because they reveal the reasons why users believe a certain outcome will occur. Moreover, these embodiments can reveal how important each of those reasons is to users in reaching their conclusions. These embodiments remain useful even after a relevant event, series of events, or portion of an event ends as they aid in analyzing people's beliefs about the expected outcomes of a future event, series of events, or portion of an event, with qualities similar to the one that was the subject of the prior prediction. For example, information acquired through these embodiments about users' reasons for predicting certain outcomes in the past might reveal beliefs in the broader community that explain, e.g., a current stock price, political poll, or betting line.

Certain embodiments of the present invention can allow users to be rewarded for making gambling and investment-related predictions without risking any money. These embodiments are beneficial for a number of reasons. For one, these embodiments can allow users to satisfy their urge to gamble or speculate, but without the potential to lose money, and while also complying with at least U.S. gambling laws. Moreover, these embodiments are particularly powerful if the social networking system issues rewards that users can sell on a secondary market as users are able to realize a profit from gambling and investment-related knowledge without actually gambling or investing. This allows users that might traditionally choose not to gamble or speculate due to their loss aversion to profit from their insights. In addition, these embodiments encourage users that suffer from loss aversion to share their insights with others, whereas traditionally they might not share these insights, which in turn provides the marketplace with more robust information.

Certain embodiments of the present invention assist in the discovery of experts. For example, in some embodiments, users are incentivized to provide feedback that helps identify experts who have the ability to accurately predict outcomes of events, series of events, or portions of events.

For the purposes of this disclosure, the rewards a social networking system awards users are sometimes referred to as “tokens.” However, use of the term “tokens” is not intended to limit the types of rewards that may be awarded within a social networking system that is consistent with the embodiments disclosed. Depending on context, and as is reasonable, the terms “tokens” and “rewards” may be used interchangeably herein.

### System Architecture

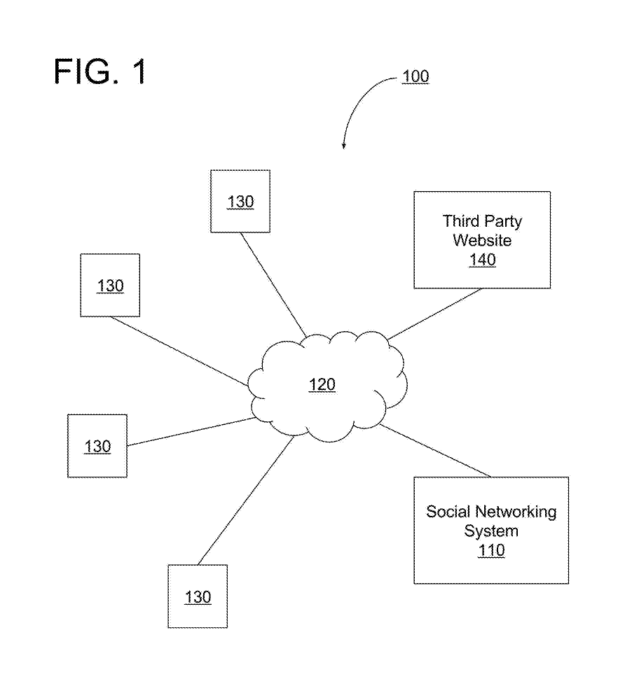

FIG. 1 is a block diagram illustrating a system environment 100 for a social networking system 110, in accordance with some embodiments of the invention. The system environment 100 comprises the social networking system 110, a network 120, one or more client devices 130, and one or more third-party websites 140. In alternative configurations, different and/or additional components may be included in the system environment 100. The embodiments described herein may be adapted to online systems that are not social networking systems.

A client device 130 is a computing device capable of receiving user input as well as transmitting and/or receiving data via the network 120. In some embodiments, a client device 130 is capable of receiving input from participants in social networking system 110 that may or may not be users, such as participants inputting information regarding the outcomes of events, series of events, or portions of events. In one embodiment, a client device 130 is a conventional computer system, such as a desktop or laptop computer. In another embodiment, a client device 130 may be a device having computer functionality, such as a personal digital assistant (PDA), mobile telephone, smart-phone or similar device. A client device 130 is configured to communicate via the network 120. In one embodiment, a client device 130 executes an application allowing a user of the client device 130 to interact with the social networking system 110. For example, a client device 130 executes a browser application to enable interaction between the client device 130 and the social networking system 110 via the network 120. In another embodiment, a client device 130 interacts with the social networking system 110 through an application programming interface (API) that runs on the native operating system of the client device 130, such as iOS or ANDROID.

The client devices 130 are configured to communicate via the network 120, which may comprise any combination of local area and/or wide area networks, using both wired and wireless communication systems. In one embodiment, the network 120 uses standard communications technologies and/or protocols. Thus, the network 120 may include links using technologies such as Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and Interledger Protocol (ILP). Data exchanged over the network 120 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

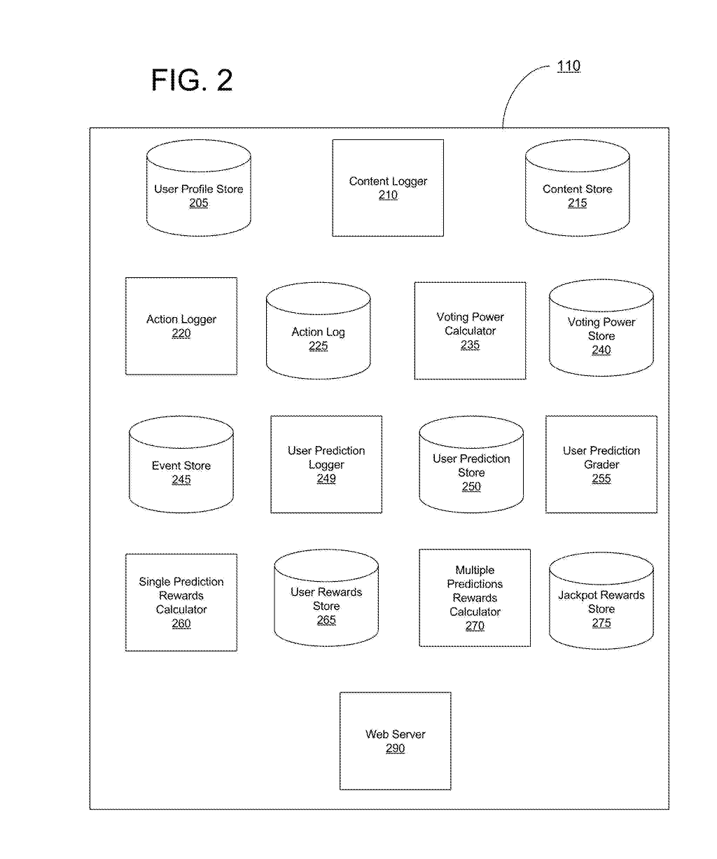

A third party website 140 may be coupled to the network 120 for communicating with the social networking system 110, which is further described below in conjunction with FIG. 2. In one embodiment, the third party website 140 is an electronic mail server or another messaging server receiving messages from users and routing the received messages to other users for presentation via client devices 130. In some embodiments, the third party website 140 is an application programming interface. In certain embodiments, the third party website 140 may maintain accounts for various users and directs messages to various user accounts to communicate messages or other content to the users. In one embodiment, the third party website 140 is a decentralized application.

FIG. 2 is an example block diagram of an architecture of a social networking system 110, in accordance with some embodiments of the invention. The social networking system 110 includes a user profile store 205, a content logger 210, a content store 215, an action logger 220, an action log 225, a voting power calculator 235, a voting power store 240, an event store 245, a user prediction logger 249, a user prediction store 250, a user prediction grader 255, a single prediction rewards calculator 260, a user rewards store 265, a multiple predictions rewards calculator 270, a jackpot rewards store 275, and a web server 290. In other embodiments, the social networking system 110 may include additional, fewer, or different components for various applications. Conventional components such as network interfaces, security functions, load balancers, failover servers, management and network operations consoles, and the like are not shown so as to not obscure the details of the system architecture.

Each user of the social networking system 110 is associated with a user profile, which is stored in the user profile store 205. A user profile includes declarative information about the user that was explicitly shared by the user, and may also include profile information inferred by the social networking system 110. In one embodiment, a user profile includes multiple data fields, each data field describing one or more attributes of the corresponding user of the social networking system 110. The user profile information stored in user profile store 205 describes the users of the social networking system 110. Examples of information stored in a user profile may include biographic, demographic, and other types of descriptive information, such as gender, location, preferences, favorite sports teams, favorite stocks, favorite cryptocurrencies, and the like. A user profile may also store other information provided by the user, for example, images or videos. In addition, in some embodiments, a user profile store may also maintain a record of user transactions, including, but not limited to, transfers of tokens between users.

A user profile in the user profile store 205 may also maintain references to actions by the corresponding user performed on content items in the content store 215 and stored in the action log 225. A user profile in the user profile store 205 may also maintain references to a user's predictions and/or statistics related to those predictions stored in user prediction store 250.

Additionally, a user profile may include information for communicating with a corresponding user outside of the social networking system 110. For example, the user profile may include one or more electronic mail (email) addresses for communicating content to the user through an email server, or other third party web site 140, external to the social networking system 110. As another example, a user profile may include a telephone number or other contact information for interacting with a corresponding user through a communication channel outside of the social networking system 110.

While user profiles in the user profile store 205 are frequently associated with individuals, allowing people to interact with each other via the social networking system 110, user profiles may also be stored for entities such as businesses or organizations. This allows an entity to establish a presence on the social networking system 110 for connecting and exchanging content with other social networking system users.

The content store 215 stores objects representing various types of content. Examples of content represented by an object include, but are not limited to, a post (such as a prediction-post, as explained further herein), a photo, a video, a link, an achievement (such as an achievement within the social networking system 110), a page (such as a page relating to a specific sport, sports league, sports team, bet type, asset (e.g. stock or currency), politician, political party, investing technique, betting technique), or any other type of content. In some embodiments, objects may be created by users of the social networking system 110, such as posts, schedules with information regarding events, photos, groups or applications. In some embodiments, objects may be created by content logger 210, for example based on data input by users; in such embodiments, content logger 210 populates content store 215 with the created objects. In some embodiments, objects are received from third-party applications, which may be external to the social networking system 110.

In some embodiments, one category of a post object on the social networking system 110 is a “prediction-post object,” sometimes referred to herein as a “prediction-post.” As further explained, a prediction-post is a post that includes a user's prediction regarding the potential outcome of an event, as well as at least one additional data set. In some embodiments, the at least one additional data set comprises the user's reasoning supporting the prediction.

In certain embodiments, there can be more than one type of prediction-post in a social networking system 110. For example, one type of prediction-post may be related to sports, while another type of prediction post may be related to stock investing. Moreover, by way of example, a prediction-post related to a specific sport, such as basketball, may be considered a different type of prediction-post than one related to another sport, such as football.

A prediction-post is comprised of multiple units of data and/or multiple data sets. For the purposes of this application, the phrases “unit of data” and “data set,” as well as their respective plural forms, may be used interchangeably, depending on context. In certain embodiments, these multiple data sets are two or more different types of data sets, while in other embodiments these multiple data sets are the same type of data set. In some embodiments, content logger 210 receives multiple data sets and generates a prediction-post object comprised of said multiple data sets. In some embodiments, a client device 130 generates a prediction-post object comprised of multiple data sets and communicates them to social networking system 110. In certain embodiments, social networking system 110 receives a single data set and infers one or more data sets from the single data set, then generates a prediction-post object comprised of multiple data sets.

In some embodiments, one type of data set is a user's selection from a pre-populated data set. In certain embodiments, one type of data set is freeform-content composed by a user.

In certain embodiments, a pre-populated data set may contain potential outcomes relating to an event, a series of events, or a portion of an event. A user selection of a potential outcome from a pre-populated data set constitutes that user's prediction that the potential outcome will occur.

Examples of an event include, but are not limited to, a sporting event (e.g. a football game), a political event (e.g. a presidential election), or an investing-related event (e.g. a particular time or window of time in which the value of an asset such as a stock, currency, or piece of property is measured). Examples of a series of events include, but are not limited to, multiple sporting events (e.g. multiple games being played between two teams; two or more separate games being played between different sets and/or combinations of teams; or a season of games played by one or more teams), multiple political events (e.g. various different elections), or multiple investing-related events (e.g. multiple particular times or windows of time in which the value of an asset such as a stock, currency, or piece of property is measured, or one or more particular times or windows of time in which the values of two or more assets are measured). Examples of a portion of an event include, but are not limited to, a part of a sporting event (e.g. a quarter or half of a basketball game).

Examples of potential outcomes include, but are not limited to: whether a team/group or individual will or will not win an event; whether a team or individual will or will not cover a spread (e.g. the handicap, or head start, a linesmaker gives to an underdog) in an event or portion of an event; whether the total number of points/runs/goals/etc. scored by one or both teams/individuals in an event, or in a portion of an event, is over, under, or equal to a specified value; whether an individual or group of individuals (e.g. a team, either real or fantasy) will or will not achieve a specified performance metric, or set of performance metrics, in an event, series of events, or in a portion of an event (e.g. whether a baseball player will achieve a certain number of hits in a game; whether a football player will achieve a certain number of yards in a game; whether a football player will achieve a certain number of fantasy football points in a game; whether a fantasy football roster will achieve a certain number of fantasy football points in a game; or whether a team will achieve a certain number of wins in a season); and whether the value of an asset will be over, under, or equal to a specific value. In some embodiments, one or more potential outcomes in a pre-populated data set will have one or more respective corresponding values relating to the potential return on investment (“ROI”) that can be expected by betting and/or investing based on that potential outcome occurring or not occurring. In some embodiments, corresponding potential ROI values are in the same pre-populated data set as their related potential outcomes. In some embodiments, information (for example an address or other identifier) in the pre-populated data set can be used to retrieve and/or receive corresponding values from another source.

In some embodiments, a pre-populated data set may contain possible reasons why a user may believe a particular potential outcome relating to an event, a series of events, or a portion of an event will occur. In certain embodiments, such reasons can comprise evidence allegedly supporting a user's belief relating to said potential outcome. For example, such evidence may be statistics, such as those relating to a player, team, or asset (e.g. a stock or currency). A user's selection of one or more possible reasons from a pre-populated data set constitutes the reason(s) the user believes a potential outcome will occur.

According to some embodiments of the present invention, a prediction-post is comprised of freeform-content composed by a user. With freeform-content, a user can explain the reasons why they believe a particular potential outcome relating to an event, a series of events, or a portion of an event will occur. Freeform-content can be comprised of, for example, text composed by a user and/or video composed by a user. In some embodiments, social networking system 110 can infer information in a pre-populated data set (such as a selected predicted outcome or relied-upon reasons) from freeform-content; in such cases, social networking system 110 can then generate a prediction-post object based on the freeform-content and the inferred information.

Prediction-posts comprised of at least a user prediction in the form of a selection of a potential outcome from a pre-populated data set, as well as the user's reasoning supporting that prediction (in the form of a selection from a pre-populated data set and/or in the form of freeform-content), are beneficial data structures for a number of reasons.

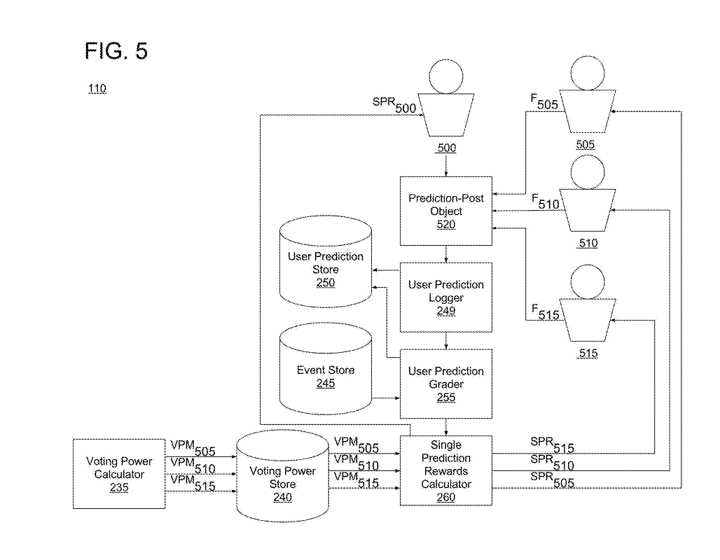

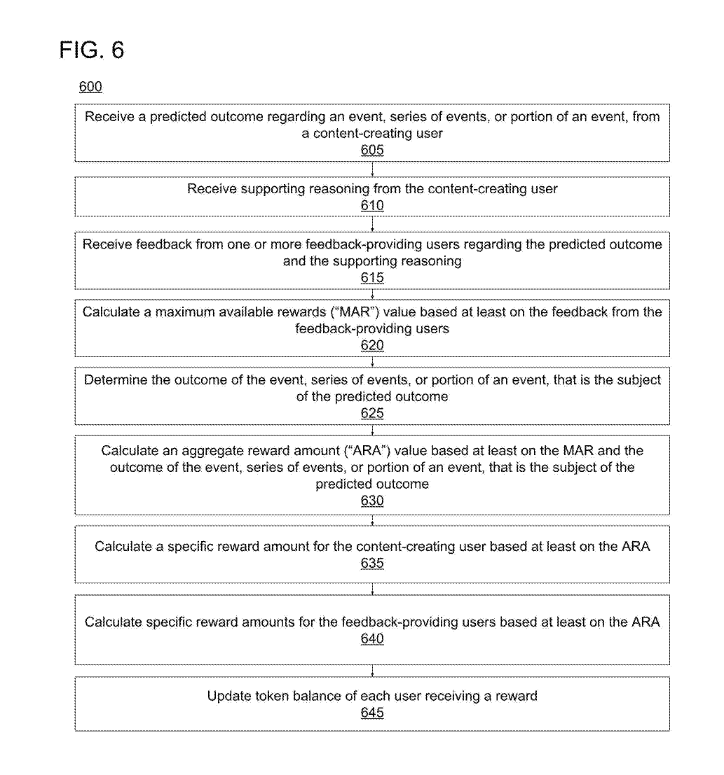

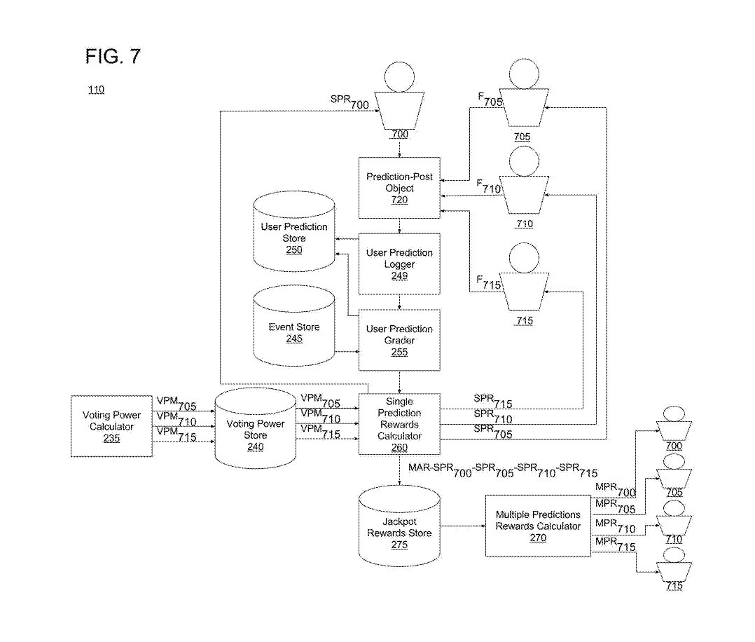

For one, such prediction-post data structures allow for social networking user reward systems and methods that lessen the incentive for users to create and/or curate low-quality content. FIGS. 5 and 7 disclose example embodiments of such reward systems, and FIGS. 6, 8, 10, and 11 disclose example embodiments of such reward methods.

The above-described prediction-post data structures are also beneficial as they result in streamlined processing of data. For example, no processing of a user's reasoning supporting a prediction is necessary in order to determine what the prediction itself is. This allows different prediction-posts that contain the same prediction, but that may contain different reasoning supporting that prediction, to be efficiently identified and linked. This is useful for being able to rapidly present information to a user desiring to read multiple posts relating to the same predicted outcome.

In some embodiments, content logger 210 may include a time stamp in a prediction-post object, for example by modifying the prediction-post object to include the time stamp. In certain embodiments, this time stamp is data relating to the receiving time of the later-received of (1) a user's selection of a potential outcome from a pre-populated data set (e.g. a user's prediction), and (2) the user's freeform-content (e.g. the user's reasoning supporting the prediction). A time stamp may be used to determine whether an event, series of events, or portion of an event, a user's prediction-post relates to occurs after the elements of the prediction-post are received by the network. This is necessary to ensure social networking system 110 does not improperly award a user for correctly predicting the outcome of an event, series of events, or portion of an event, even though the user did not make their prediction until the event, series of events, or portion of an event, has already started or has even already concluded. In some embodiments, if any elements of a prediction-post object are received after the start of the event, series of events, or portion of an event, the prediction contained in the prediction-post object relates to, the prediction-post object is not stored in content store 215.

The action logger 220 receives communications about user actions on and/or off the social networking system 110. In some embodiments, action logger 220 populates the action log 225 with information about user actions. Examples of such actions may include, but are not limited to, creating a post (such as a prediction-post) and providing feedback about a post. A user's feedback regarding a post may include, depending on the embodiment, the user expressing approval or disapproval of a post, such as through use of a vote up or down. In some embodiments, a user's feedback regarding a post can include, but is not limited to, the user expressing a level of approval or disapproval that is adjustable on a spectrum, for example from 100% disapproval to 100% approval; such an adjustable level of expression may be suitable to, for example, express the user's level of confidence in the content of a prediction-post being correct or incorrect. In some embodiments, a user may only provide approval feedback; in certain of these embodiments, there is only one type of approval feedback, rather than a spectrum of approval feedback. Feedback indicating approval of a prediction-post means the feedback-providing user is making the same prediction as is contained in the prediction-post. In some embodiments, feedback indicating disapproval of a prediction-post means the user is making a prediction opposite to the prediction contained in the prediction-post.

The action log 225 may be used by the social networking system 110 to track user actions on the social networking system 110, as well as external websites 140 that communicate information to the social networking system 110. Users may interact with and/or create various objects on the social networking system 110, including: creating a post (such as, in certain embodiments, a prediction-post); providing feedback on posts; and commenting on posts. Information describing these actions is stored in the action log 225. Additional examples of interactions with objects on social networking system 110 included in the action log 225 include communications between users, adding an event to a calendar, joining a group, creating a contest, authorizing an application, using an application and engaging in a transaction. In some embodiments, data from the action log 225 is used to infer interests or preferences of the user, augmenting the interests included in the user profile and allowing a more complete understanding of user preferences.

The action log 225 may also store user actions taken on external websites, such as third party website 140. For example, an e-commerce website for a company that accepts sports bets may recognize a user of a social networking system 110 through social plug-ins that enable the e-commerce website to identify the user of the social networking system 110. Because users of the social networking system 110 are uniquely identifiable, e-commerce websites, such as the sports betting company, may use the information about these users as they visit their websites. In some embodiments, the action log 225 records data about these users, such as webpage viewing histories, bets made, and other patterns from interacting with the third party website 140.

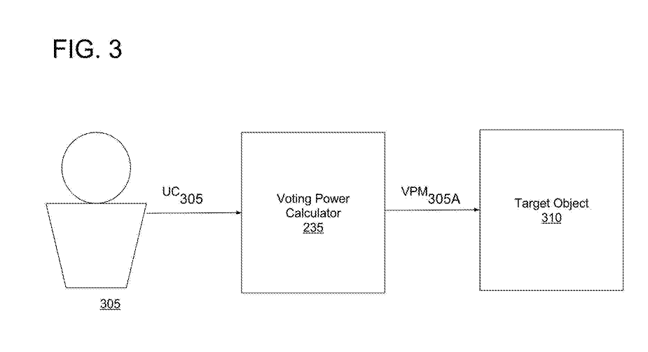

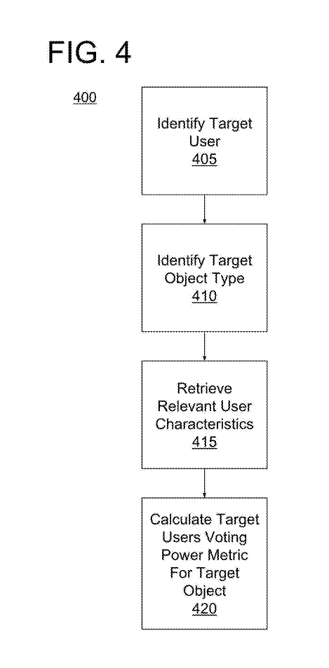

As further described in FIGS. 3 and 4, the voting power calculator 235 determines one or more voting power metrics for users of a social networking system 110. A voting power metric is a value representing the effect a specific user's feedback regarding an object has on the aggregate amount of tokens social networking system 110 awards token-earning users associated with the object. Users may become associated with an object, for example, by creating the object, or by providing feedback on it.

In some embodiments, a user can have different voting power metrics for different types of objects. In some embodiments, one or more voting power metrics are stored in voting power store 240. In some embodiments, user profile store 205 can serve the role of voting power store 240.

The event store 245 stores objects relating to one or more events that users may make predictions about. In some embodiments, event store 245 may contain one or more schedules of such events, such as a schedule relating to one or more upcoming betting and/or investing events. In certain embodiments, event store 245 may store odds or similar information relating to one or more events in a schedule. An example of “similar information” in this context is information that can be used to calculate the potential profit or loss from purchasing a particular stock put or call option (e.g. the purchase price of the option, the strike price, and the current value of a share of the relevant stock).

In some embodiments, event store 245 contains one or more data sets from which a user can make a selection. These data sets are examples of pre-populated data sets. The phrase “pre-populated” is not intended to convey that the data sets are populated prior to being stored in event store 245; rather, the phrase “pre-populated” conveys that the data set is populated prior to a user making a selection from the data set.

Examples of pre-populated data sets that may be stored in event store 245, depending on the relevant embodiment, are discussed above. For example, in certain embodiments, a pre-populated data set may contain potential outcomes relating to an event, a series of events, or a portion of an event. In addition, in some embodiments, a pre-populated data set may contain possible reasons why a user may believe a particular potential outcome relating to an event, a series of events, or a portion of an event will occur.

In certain embodiments, the event store 245 may also store information regarding the outcomes of events, series of events, or portions of events. In some of these embodiments, the event store 245 is communicated information about the outcomes from a third party website 140. In some embodiments, the event store 245 is communicated information about the outcomes from certain participants in social networking system 110 operating a client device 130. In some of these embodiments, the relevant participants are selected by users of social networking system 110, for example through an election.

The user prediction logger 249 populates user prediction store 250 with information relating to user predictions regarding events, series of events, and/or portions of events. For example, in some embodiments, user prediction logger 249 may populate user prediction store 250 with: user predictions about potential outcomes of events, series of events, and/or portions of events; potential ROI values relating to how much one can expect to win/profit and/or lose by betting and/or investing based on that potential outcome occurring or not occurring; and/or the expected likelihood of potential outcomes occurring or not occurring.

In certain embodiments, for feedback received regarding a prediction-post object, user prediction logger 249 populates user prediction store 250 with references to other data relating to the user prediction, such as the relevant prediction-post object in content store 215, and/or the relevant event, series of events, or portion of an event, and its associated information (potential ROI value(s), expected likelihood of occurring, and/or start time, etc.) in event store 245.

In certain embodiments, user prediction logger 249 receives communications about user predictions on the social networking system 110, for example from a client device 130. In certain embodiments, user prediction logger 249 retrieves information regarding user predictions, for example from content store 215.

In some embodiments, a user prediction is received as part of a prediction-post that contains the user's prediction (e.g. the user's selected prediction from a pre-populated data set). In some embodiments, a user prediction is received in the form of a user's feedback regarding another user's prediction-post that contains a prediction.

In some embodiments, a user prediction is retrieved by user prediction logger 249 from a prediction-post stored in content store 215. In certain embodiments, a user prediction is retrieved or inferred by user prediction logger 249 from information in action log 225 regarding a user's feedback regarding another user's prediction-post that contains a prediction. In certain embodiments, action logger 220 may also be user prediction logger 249.

In some embodiments, user prediction logger 249 populates user prediction store 250 with potential ROI values corresponding to how much one can expect to win/profit and/or lose by betting and/or investing based on predicted potential outcomes occurring or not occurring. In some of these embodiments, user prediction logger 249 may retrieve such potential ROI values from event store 245 and/or content store 215. In certain embodiments, user prediction logger 249 receives such potential ROI values as part of a prediction-post.

The user prediction store 250 stores user predictions regarding the potential outcomes of events, series of events, and/or portions of events. User prediction store 250 is populated with user predictions by user prediction logger 249.

In some embodiments, user prediction logger 249 populates user prediction store 250 with an expected likelihood of potential outcomes occurring. In some of these embodiments, user prediction logger 249 may retrieve such expected likelihoods from event store 245 and/or content store 215. In certain embodiments, user prediction logger 249 receives such expected likelihoods as part of a prediction-post.

In certain embodiments, in addition to storing user predictions, user prediction store 250 also stores information regarding the accuracy of the user predictions based on the outcomes of the relevant events, series of events, and/or portions of events. User prediction grader 255 evaluates the accuracy of user predictions stored in user prediction store 250. To do so, user prediction grader 255 utilizes information in event store 245 regarding the outcomes of events, series of events, and/or portions of events. User prediction grader 255 then updates user prediction store 250 to reflect whether user predictions accurately predicted the outcomes. In some embodiments, the accuracy of a user prediction is assessed in a binary way—i.e. the prediction was correct or incorrect. In certain embodiments, the accuracy of a user prediction may be assessed based on how far off it was from the actual outcome—e.g. if a team loses by 4 points, then a prediction of that team losing by 5 points is considered more accurate than a prediction of that team losing by 10 points.

According to certain embodiments of the present invention, the information regarding the accuracy of user predictions may be utilized by rewards calculators, such as single prediction rewards calculator 260 and/or multiple predictions rewards calculator 270, in order to determine amounts of tokens to award users. In addition, in some embodiments, the information regarding the accuracy of user predictions may be utilized by voting power calculator 235 in order to calculate one or more voting power metrics.

As further explained in relation to FIGS. 5, 6, 7, 8, 9, 10, and 11, the single prediction rewards calculator 260 calculates how many, if any, tokens to award to one or more users in relation to a single prediction. If single prediction rewards calculator 260 determines that the one or more users have earned any tokens, single prediction rewards calculator 260 updates the users' respective token balances in user rewards store 265. Single prediction rewards calculator 260 calculates such rewards utilizing information stored in user prediction store 250 and/or event store 245. In certain embodiments, single prediction rewards calculator 260 calculates user rewards utilizing one or more voting power metrics stored in voting power store 240. In certain embodiments, user profile store 205 may perform the functions of user rewards store 265. As noted previously, in certain embodiments, a prediction may be communicated by a user through information in their prediction-post, or by a user providing feedback on another user's prediction-post.

As described in relation to FIGS. 5, 6, 7, 8, 10, and 11, in some embodiments, a single prediction rewards calculator 260 may calculate one or more possible user reward amounts related to a prediction-post. If single prediction rewards calculator 260 determines that one or more users have earned any tokens, single prediction rewards calculator 260 updates the users' respective token balances in user rewards store 265.

In certain embodiments, single prediction rewards calculator 260 calculates a maximum available rewards amount (“MAR”) that may potentially be awarded to one or more token-earning users associated with a particular prediction and/or prediction-post. In some embodiments, single prediction rewards calculator 260 calculates a lowest available rewards amount (“LAR”) that may potentially be awarded to one or more token-earning users associated with a particular prediction and/or prediction-post. In some embodiments, single prediction rewards calculator 260 calculates an aggregate reward amount (“ARA”) that is actually awarded to one or more token-earning users associated with a particular prediction and/or prediction-post.

In some embodiments, a MAR is related to a prediction-post, and single prediction rewards calculator 260 awards an ARA equal to the MAR to the users associated with the prediction-post if the prediction contained in the prediction-post is accurate. In addition, in certain embodiments, rewards calculator 260 calculates a LAR related to a prediction-post, with the LAR being less than the MAR related to the prediction-post. In some of the embodiments in which a LAR is calculated, single prediction rewards calculator 260 awards an ARA equal to the LAR to the users associated with the prediction post if the prediction contained in the prediction-post is inaccurate. In some of the embodiments in which a LAR is calculated, if the prediction contained in a prediction-post is inaccurate, single prediction rewards calculator 260 may award the one or more users associated with the prediction-post with an ARA between the LAR and the MAR based on the degree to which the prediction differed from the result of the event the prediction related to. In certain embodiments in which single prediction rewards calculator 260 calculates a MAR, when an amount less than the MAR is awarded as the ARA, single prediction rewards calculator 260 updates jackpot rewards store 275 to reflect that the difference between the MAR and the ARA (i.e. the portion of the MAR that is not awarded) is part of a jackpot prize pool.

As further explained in relation to FIGS. 7, 8, and 11, in certain embodiments, a multiple predictions rewards calculator 270 calculates how many tokens to award to each user that accomplishes one or more goals related to multiple predictions. For example, in certain embodiments, a multiple predictions rewards calculator 270 may calculate how many tokens to award a user for correctly predicting a certain number of events in a row.

If multiple predictions rewards calculator 270 determines that a user has earned any tokens, multiple prediction rewards calculator 270 updates the user's token balance in user rewards store 265. In certain embodiments, multiple predictions rewards calculator 270 calculates rewards utilizing information stored in jackpot rewards store 275 and one or more of user prediction store 250 and event store 245. In certain embodiments, user profile store 205 may perform the functions of user rewards store 265. As noted previously, in certain embodiments, a prediction may be communicated by a user through information in a prediction-post, or by a user providing feedback on another user's prediction-post.

User rewards store 265 stores information regarding user token balances. For example, user rewards store 265 stores information regarding users' current respective token balances. In some embodiments, user rewards store 265 stores information regarding users' respective lifetime token earnings. In certain embodiments, user rewards store 265 stores information regarding how many tokens users earned in relation to specific types of prediction-posts. In some embodiments, user rewards store 265 stores information regarding how many tokens users earned during specific windows of time.

Jackpot rewards store 275 stores information regarding one or more jackpot prize pools. In certain embodiments, the balance of a jackpot prize pool may be drawn down in order to reward one or more users for completing one or more goals related to multiple predictions.

The web server 290 links the social networking system 110 via the network 120 to the one or more client devices 130, as well as to the one or more third party websites 140. The web server 290 serves web pages, as well as other web-related content, such as JAVA®, FLASH®, XML and so forth. The web server 290 may provide the functionality of receiving and routing messages between the social networking system 110 and one or more client devices 130, and/or one or more third party websites 140, for example, instant messages, queued messages (e.g., email), text and SMS (short message service) messages, or messages sent using any other suitable messaging technique. A user may send a request to the web server 290 to upload information, for example, images or videos that are stored in the content store 215. Additionally, the web server 290 may provide API functionality to send data directly to native client device operating systems, such as iOS or ANDROID, and/or third party websites 140.

### Social Networking Voting Power Calculator

FIG. 3 is a block diagram of a process for determining one or more voting power metrics for users of the social networking system 110, according to some embodiments. As previously mentioned above, a voting power metric is a value representing the effect a specific user's feedback regarding an object has on the aggregate amount of tokens the social networking system 110 awards token-earning users associated with the object.

In some embodiments of the present invention, one or more voting power metrics are utilized by one or more rewards calculators, such as single prediction rewards calculator 260, in calculating user rewards related to prediction-posts.

As shown in FIG. 3, voting power calculator 235 identifies a target user 305 and the type of a target object 310. For the purposes of explanation, target object 310 is considered of “A” type. Voting power calculator 235 then retrieves the relevant user characteristics UC₃₀₅ of target user 305. Potentially relevant user characteristics that may be used in some embodiments are discussed below. Relevant user characteristics may be stored in one or more stores, including, but not limited to, user profile store 205, action log 225, user prediction store 250, or user rewards store 265.

After retrieving user characteristics UC₃₀₅, voting power calculator 235 calculates a voting power metric VPM_{305A} for target user 305 that is specific to the type of target object 310—here, for the purposes of explanation, an object of type “A”.

Voting power calculator 235 performs a calculation that may vary based on the embodiment. For example, user characteristics UC₃₀₅ may comprise individual user characteristics that may have differing levels of impact on a voting power metric calculation based on the embodiment. Moreover, user characteristics UC₃₀₅ may comprise different user characteristics from embodiment to embodiment.

In some embodiments, voting power calculator 235 calculates a voting power metric related to a specific type of object when a user provides feedback on an object of that type. In certain embodiments, voting power calculator 235 calculates one or more voting power metrics for a user according to a schedule (such as a set interval of time), regardless of whether the user provides feedback regarding a specific object.

In some embodiments, voting power calculator 235 can calculate more than one voting power metric for a user. For example, a different voting power metric may be calculated for a user in relation to one type of object (such as prediction-posts relating to basketball games), than may be calculated for a user in relation to another type of object (such as prediction-posts relating to football games).

In some embodiments, voting power calculator 235 calculates a voting power metric at least based on the user characteristic of the current amount of tokens associated with a user's account, for example as reflected in user rewards store 265. In certain of these embodiments, a user has one voting power metric and it is equal to this user characteristic.

In certain embodiments, a voting power metric is calculated by voting power calculator 235 according to the following formula:

Voting Power Metric=User's Current Token Holdings*(1+Voting Power Factors Coefficient)

A voting power factors coefficient (herein referred to as a “VPF coefficient”) influences the value of a voting power metric (“VPM”) by increasing it or decreasing it based on one or more user characteristics. The one or more user characteristics utilized in determining a VPF coefficient can vary based on the embodiment. In addition, in some embodiments, a VPM may be calculated by voting power calculator 235 using the following formula: VPM=1+VPF coefficient. In certain of these embodiments, a user's current token balance impacts the value of the voting power factors coefficient. In some embodiments, a user's current token balance has no impact on a VPM calculation.

In certain embodiments, the value of a VPM may not go below zero.

In certain embodiments, voting power calculator 235 calculates a voting power metric at least based on the user characteristic of the total amount of tokens that have ever been associated with a user's account. For example, voting power calculator 235 may add an additional 0.05 to a VPF coefficient for every 1000 tokens that have ever been associated with a user's account. In some embodiments, voting power calculator 235 calculates a voting power metric at least based on the user characteristic of the amount of tokens a user has been awarded over some specific window of time, such as a current sports season, a company's most recent quarter(s), or the most recent month. For example, voting power calculator 235 may add an additional 0.05 to a VPF coefficient for every 1000 tokens that a user wins during a football season.

The embodiments described in the paragraph above, as well as the embodiments that involve voting power calculator 235 calculating a VPM at least based on the current amount of tokens associated with a user's account, incentivize users to actively participate in social networking system 110 in order to receive its rewards, and thereby become more influential within the system. Moreover, these embodiments can encourage user activity that is presumptively beneficial for social networking system 110 as it encourages previously-rewarded users to continue the same activity that led to their prior rewards.

In some embodiments, voting power calculator 235 calculates a voting power metric at least based on the user characteristic of the total amount of reward tokens that have ever been awarded to a user in relation to posts about specific types of events (such as events related to a specific sport, a particular stock, or a particular category of stocks). For example, when calculating a user's voting power metric for football posts, voting power calculator 235 may add an additional 0.05 to a VPF coefficient for every 1000 tokens that a user has ever won in relation to football posts. In addition to providing the benefits highlighted in the previous paragraph, the embodiments disclosed in this paragraph allow the feedback of users that are presumptively the most expert on the network about particular event types to have increased influence on the rewards given in relation to posts about those event types. Moreover, this structure encourages a user to focus their activity in social networking system 110 on posts about event types that the users is most knowledgeable about as that activity is the most likely to get rewarded.

In some embodiments, voting power calculator 235 calculates a voting power metric based at least on the accuracy of a user's predictions. Such accuracy can be assessed in different ways in different embodiments.

In some embodiments, the accuracy of a user's prediction results is assessed in binary terms, with the total number of correct predictions weighed against the total number of predictions made, and not taking into account the relative before-the-fact likelihood of those events, series of events, and/or portions of events occurring. For example, voting power calculator 235 may evaluate the percent of predicted event outcomes a user got correct, and add an additional 0.05 to a VPF coefficient for every 5% above 50%.

In some embodiments, the accuracy of a user's prediction results is assessed based at least in part on the before-the-fact expected likelihoods of the respective predicted outcomes occurring (e.g. the odds), as according to, for example, a prediction market, sportsbook, or investment brokerage. Such an approach accounts for differing before-the-fact likelihoods of different events occurring. In addition, this approach incentivizes a user to make predictions that would result in a positive return on investment (“ROI”) if the user were to bet or invest based upon that prediction in a prediction market, sportsbook, or investment brokerage. By way of example, voting power calculator 235 may account for a user's accuracy in this way by adding 0.05 to a VPF coefficient if a user achieves a positive hypothetical ROI within social networking system 110, and an additional 0.05 to the VPF coefficient for every 5% the user achieves above zero.

In certain embodiments in which voting power calculator 235 calculates a voting power metric based at least on the accuracy of a user's predictions, such accuracy may be evaluated in relation to posts about specific types of events (such as events related to a specific sport, a specific sports league, a particular stock, or a particular category of stocks).

In certain embodiments in which voting power calculator 235 calculates a voting power metric based at least on the accuracy of a user's predictions, such accuracy may be evaluated based on the user's relevant predictions over the lifetime of the user's account.

In certain embodiments in which voting power calculator 235 calculates a voting power metric based at least on the accuracy of a user's predictions, such accuracy may be evaluated based on the user's relevant predictions over a window of time. Calculating a voting power metric based on prediction results over a window of time—such as one week, one month, or one sport season—rather than lifetime prediction results, lessens the incentive for a user to create a new account in order to avoid having their prior incorrect predictions negatively impact their influence in social networking system 110.

In some embodiments, voting power calculator 235 calculates a voting power metric based at least on the age of a user's account, for example as reflected in user profile store 205. This approach is beneficial as it discourages existing users with potentially negative qualities related to their account, such as a poor prediction track record, from simply creating a new account and abandoning the old account. Account abandonment results in negative consequences, such as the added costs related to storing the abandoned account. Moreover, account abandonment results in users not being able to fully trust the prediction records of other users. By way of example, voting power calculator 235 may calculate a voting power metric based at least on the age of a user's account by adding 0.01 to a VPF coefficient for every year a user's account has existed.

In certain embodiments, voting power calculator 235 calculates a voting power metric based at least on a user's amount of activity (“experience”) on the network. Examples of activity on the network include composing posts, providing feedback on posts, and commenting on posts. In some embodiments, voting power calculator 235 calculates a voting power metric based at least on the number of times a user has composed posts. In certain embodiments, voting power calculator 235 calculates a voting power metric based at least on the number of times a user has provided feedback regarding posts. In some embodiments, voting power calculator 235 calculates a voting power metric based at least on the number of times a user has commented on posts. The embodiments disclosed in this paragraph discourage users from creating new accounts in order to avoid any negative impact from previously poorly predicting the outcome of events, series of events, and/or portions of events. By way of example, voting power calculator 235 may calculate a voting power metric based at least on a user's amount of activity (“experience”) on the network by adding 0.0001 to a VPF coefficient for every time the user has provided feedback on a post, and by adding 0.0005 to a VPF coefficient for every time the user has composed a post. By way of example, voting power calculator 235 may calculate a voting power metric based at least on the number of times a user has composed posts by adding 0.0005 to a VPF coefficient for every time the user has composed a post. By way of example, voting power calculator 235 may calculate a voting power metric based at least on the number of times a user has provided feedback regarding posts by adding 0.0001 to a VPF coefficient for every time the user has provided feedback on a post. By way of example, voting power calculator 235 may calculate a voting power metric based at least on the number of times a user has commented on posts by adding 0.0001 to a VPF coefficient for every time the user has commented on a post.

The concept of “MAR” (“maximum available rewards”) is discussed later in this disclosure. In some embodiments in which a MAR is calculated, voting power calculator 235 calculates a voting power metric based at least on MARs associated with posts composed by a user. In certain of these embodiments, a voting power metric is based at least on the total of the MARs associated with posts composed by a user. In certain embodiments, a voting power metric is based at least on the average of the MARs associated with posts composed by a user. In certain embodiments, a voting power metric is based at least on MARs associated with a user's posts of a particular type (for example, posts about football). By way of example, voting power calculator 235 may calculate a voting power metric based at least on MARs associated with posts composed by a user by summing all MARs associated with a user's posts and adding 0.001 to a VPF coefficient for every 1000 tokens in that summation. By way of another example, voting power calculator 235 may calculate a voting power metric based at least on MARs associated with posts composed by a user by averaging all MARs associated with a user's posts and comparing that average to the average MAR for all posts on social networking system 110, then for every 5% the user's MAR is above the average MAR of all posts, adding 0.01 to a VPF coefficient. The embodiments disclosed in this paragraph encourage a user to create high-quality posts that are received well by other users, even if the user that composes the post is unskilled at making predictions.

In some embodiments, one or more voting power metrics are stored in voting power store 240. In some embodiments, user profile store 205 can serve as voting power store 240.

FIG. 4 is a flow chart of a method 400 for determining a voting power metric maintained by a social networking system 110, in accordance with some embodiments. It should be noted that method 400 is only exemplary and should not be construed in a limiting fashion. For example, additional and/or substitute steps to those illustrated may be practiced within the scope of the present invention and in one or more embodiments one or more steps to those illustrated may be omitted or modified. Similarly, the steps may be performed in a different order from that illustrated in FIG. 4, as is reasonable and desired.

A target user is identified 405 by the voting power calculator 235. Voting power calculator 235 also identifies 410 a target object type. In certain embodiments, a target object type is identified 410 when a user provides feedback on an object of that type. In some embodiments, a target object type is identified 410 according to a schedule (such as a set interval of time).

As described above, there can be a variety of target object types in social networking system 110. In certain embodiments, social networking system 110 may consider all prediction-posts to be of type “prediction-post.” In some embodiments, social networking system 110 may differentiate different types of prediction-posts—for example, prediction-posts about basketball may be considered to be of type “basketball prediction-post” while prediction-posts about football may be considered to be of type “football prediction-post.”

The voting power calculator 235 retrieves 415 the target user's user characteristics relevant to the target object type. Examples of potentially relevant user characteristics, depending on the embodiment, are described above in conjunction with FIG. 3. In various embodiments, the relevant user characteristics are retrieved from, for example, user profile store 205, content store 215, action log 225, user prediction store 250, and/or user rewards store 265. The relevant user characteristics are then used by voting power calculator 235 to calculate 420 the target user's voting power metric for the target object type. As described in relation to FIG. 3, the relevant user characteristics may be utilized in any suitable manner to generate the voting power metric.

In some embodiments, voting power calculator 235 calculates a user's voting power metric related to a specific type of object when the user provides feedback on an object of that type. In certain embodiments, voting power calculator 235 calculates a user's voting power metrics related to different types of objects at set intervals, regardless of whether the user provides feedback regarding a specific object.

### Social Networking Rewards Calculator(s)

FIG. 5 is a block diagram illustrating a method for determining one or more reward amounts to award one or more users of a social networking system 110, according to some embodiments. As shown in FIG. 5, prediction-post object 520 includes data representing a prediction and supporting reasoning of content-creating user 500. For example, in certain embodiments, prediction-post object 520 may comprise a prediction selected by user 500 from a pre-populated data set, as well as freeform-content composed by user 500.

In the example of FIG. 5, social networking system 110 receives feedback F₅₀₅ from user 505, feedback F₅₁₀ from user 510, and feedback F₅₁₅ from user 515, regarding prediction-post object 520. In FIG. 5, feedback F₅₀₅, F₅₁₀, and F₅₁₅ represent, for example, votes of approval by users 505, 510, and 515, respectively. As discussed previously, levels of approval may be less than 100% approval. While FIG. 5 illustrates three users providing feedback, any number of users may provide feedback regarding prediction-post object 520.

User prediction logger 249 determines if feedback F₅₀₅, F₅₁₀, and F₅₁₅ are received by social networking system 110 before the start of the relevant event, series of events, or portion of an event to which the prediction contained in prediction-post object 520 relates. Upon determining feedback F₅₀₅, F₅₁₀, and F₅₁₅ were received prior to the start of the relevant event, series of events, or portion of an event, the user prediction logger 249 updates user prediction store 250 to reflect that users 505, 510, and 515 are each making the same prediction as is included in prediction-post object 520, and that each prediction is related to prediction-post object 520.

After completion of the relevant event, series of events, or portion of an event that the prediction relates to, user prediction grader 255 determines the accuracy of the prediction based on retrieving information stored in event store 245 regarding the outcome of the event, series of events, or portion of an event and comparing the actual outcome to the predicted outcome. User prediction grader 255 updates user prediction store 250 to reflect whether the prediction of users 500, 505, 510, and 515 is accurate.

Single prediction rewards calculator 260 retrieves from voting power store 240 the voting power metrics VPM₅₀₅, VPM₅₁₀, and VPM₅₁₅ calculated by voting power calculator 235 for users 505, 510, and 515, respectively. If any of feedback F₅₀₅, F₅₁₀, and F₅₁₅ indicated a level of approval less than 100% for prediction-post object 520, single prediction rewards calculator 260 provides less weight to the voting power metric of any user associated with the relevant feedback. For example, in certain embodiments, the voting power metrics VPM₅₀₅, VPM₅₁₀, and/or VPM₅₁₅ are given a weight discounted by single prediction rewards calculator 260 proportionally to the amount below 100% approval that feedback F₅₀₅, F₅₁₀, and/or F₅₁₅ respectively reflect (e.g., if F₅₀₅ indicates 65% approval of prediction-post object 520, single prediction rewards calculator 260 will use 0.65*VPM₅₀₅ instead of VPM₅₀₅ in any calculations in which single prediction rewards calculator 260 would have used VPM₅₀₅ if 100% approval of prediction-post object 520 were involved).

In some embodiments, feedback may indicate disapproval. In certain of these embodiments, feedback indicating disapproval results in the relevant user's relevant voting power metric being given a negative weight by single prediction rewards calculator 260 proportional to the amount below 0% the disapproval corresponds to. For example, in some embodiments, if feedback indicates that a user fully disapproves of a post, the user's relevant voting power metric will be multiplied by −1, and if feedback indicates that a user 65% disapproves of a post, the user's relevant voting power metric will be multiplied by −0.65.

Single prediction rewards calculator 260 calculates a maximum available rewards value (“MAR”) utilizing VPM₅₀₅, VPM₅₁₀, and VPM₅₁₅, weighted as appropriate, as well as additional information, as discussed below.

Specifically, in some embodiments, single prediction rewards calculator 260 sums VPM₅₀₅, VPM₅₁₀, and VPM₅₁₅, one or more of which may be possibly weighted, as mentioned above, prior to summing. Single prediction rewards calculator 260 then divides the sum of the voting power metrics VPM₅₀₅, VPM₅₁₀, and VPM₅₁₅ (respectively weighted when appropriate) by the summed total of voting power metrics for all feedback received on social networking system 110 during the current voting window. The result of this division operation is then multiplied by the total amount of rewards social networking system 110 is scheduled to reward during the current window of time to all content-creating and feedback-providing users, yielding a maximum available rewards amount (“MAR”) that may be awarded to the aggregate of users 500, 505, 510, and 515, if the prediction included in prediction-post object 520 is accurate.

In some embodiments, a MAR may be calculated by utilizing one or more voting power metrics that are exponentiated. In certain embodiments, a MAR may be calculated by utilizing one or more voting power metrics as exponents.

In certain embodiments in which feedback may indicate disapproval, if the sum of the voting power metrics VPM₅₀₅, VPM₅₁₀, and VPM₅₁₅ (respectively weighted when appropriate) is equal to a negative number, the value 0 is used instead of the sum. This approach is beneficial at least because it prevents users from losing tokens as a result of another user's disapproval feedback.

In some embodiments, if the summed total of voting power metrics for all feedback received on social networking system 110 during the current voting window is equal to zero, no tokens are awarded. This approach is beneficial at least in order to address the problem of a MAR calculation involving dividing by zero. In some embodiments, if the summed total of voting power metrics associated with a particular prediction-post is a negative number, that summed total will be replaced by zero in the calculation of MARs related to other prediction-posts of social networking system 110. This approach is beneficial at least because it prevents one prediction-post with significant disapproval feedback from drastically altering the amount of tokens awarded in relation to other prediction-posts.

In some embodiments, if the summed total of voting power metrics for all feedback received on social networking system 110 during the current voting window is equal to a negative number, all MARs during that voting window equal zero. This approach is beneficial at least in order to ensure users do not lose tokens.

In some embodiments, a MAR related to a prediction-post cannot drop below zero. In certain of these embodiments, a MAR may remain at zero until voting power metrics of users providing disapproval feedback are overcome by at least more than an equal level of voting power metrics of users providing approval feedback.

In some embodiments, single prediction rewards calculator 260 does not utilize any voting power metrics in calculating a MAR. In some of these embodiments, all user feedback regarding a prediction-post influences the MAR calculation equally. For example, in some embodiments, users may only provide approval feedback, and such approval feedback may only have one form—100% approval. In some embodiments, user feedback may be either approval or disapproval, but there is only one form of approval and one form of disapproval; as a result, all approval equally influences the MAR calculation (e.g. each user approval feedback counts as 1 in the MAR calculation), and all disapproval equally influences the MAR calculation (e.g. each user disapproval feedback counts as −1 in the MAR calculation).

In certain embodiments, single prediction rewards calculator 260 calculates a MAR only if a prediction contained in a prediction-post is accurate. In some embodiments, single prediction rewards calculator 260 calculates a MAR regardless of whether a prediction contained in a prediction-post is accurate. For example, single prediction rewards calculator 260 may calculate a MAR prior to the start or occurrence of the event relating to prediction-post 520. In certain embodiments, single prediction rewards calculator 260 may dynamically calculate a MAR related to a prediction-post. For example, single prediction rewards calculator 260 may calculate a new MAR each time a new user provides feedback regarding a prediction-post.

In certain embodiments, in addition to a MAR, single prediction rewards calculator 260 also calculates a lowest available rewards amount (“LAR”). Single prediction rewards calculator 260 calculates a LAR by multiplying a MAR by the expected probability of the predicted outcome not occurring. In other words, LAR=MAR*(expected probability of the predicted outcome not occurring).

In certain embodiments, single prediction rewards calculator 260 can access the expected probability of the predicted outcome not occurring from either user prediction store 250, event store 245, or content store 215, depending on the embodiment. Alternatively, in some embodiments, single prediction rewards calculator 260 can calculate the expected probability of the predicted outcome not occurring. For example, to perform this calculation, single prediction rewards calculator 260 may retrieve the expected probability of the predicted outcome occurring (such as from either user prediction store 250, event store 245, or content store 215, depending on the embodiment), and subtracting that percentage from 100%.

In some embodiments, single prediction rewards calculator 260 can calculate the expected probability of the predicted outcome not occurring by utilizing the ROI for a correct prediction. Specifically, single prediction rewards calculator 260 may retrieve the ROI for a correct prediction (for example from user prediction store 250, event store 245, or content store 215, depending on the embodiment) and then apply that potential ROI in the following formula to determine the expected probability of the predicted outcome not occurring:

$$1 - ( \frac{1}{ROI + 1} ) .$$

The result of that formula is then multiplied by the MAR in order to determine a LAR; in other words,

$$LAR = MAR * ( 1 - ( \frac{1}{ROI + 1} ) ) .$$

In certain embodiments, single prediction rewards calculator 260 calculates a LAR only if a prediction contained in a prediction-post is inaccurate. In some embodiments, single prediction rewards calculator 260 calculates a LAR regardless of whether a prediction contained in a prediction-post is inaccurate. For example, single prediction rewards calculator 260 may calculate a LAR prior to the start or occurrence of the event relating to prediction-post 520. In certain embodiments, single prediction rewards calculator 260 may dynamically calculate a LAR related to a prediction-post. For example, single prediction rewards calculator 260 may calculate a new LAR each time a new user provides feedback regarding a prediction-post.

In certain embodiments, single prediction rewards calculator 260 utilizes the LAR and/or the MAR to calculate one or more potential specific reward amounts for each of the content-creating user and the feedback-providing users. In other words, in these embodiments, single prediction rewards calculator 260 may calculate one or more potential reward amounts for each user associated with a relevant prediction-post.

Single prediction rewards calculator 260 accesses user prediction store 250 in order to determine, based on the outcome of the event relating to prediction-post 520, the accuracy of the prediction made by users 500, 505, 510, and 515 in relation to prediction-post 520. Afterward, single prediction rewards calculator 260 determines an aggregate reward amount (“ARA”) for the content-creating user and the feedback-providing users related to the prediction-object. In the example of FIG. 5, single prediction rewards calculator 260 calculates the aggregate value of SPR₅₀₀, SPR₅₀₅, SPR₅₁₀, and SPR₅₁₅, which represent the reward amounts for users 500, 505, 510, and 515, respectively. The ARA is this aggregate value; in other words, ARA=SPR₅₀₀ SPR₅₀₅+SPR₅₁₀+SPR₅₁₅. If the prediction is accurate, the ARA equals the MAR. In certain embodiments, if the prediction is inaccurate, the ARA equals the LAR. In some embodiments, however, if the prediction is inaccurate, the ARA may be an amount between the LAR and the MAR, the precise amount being based on the degree to which the prediction differed from the result of the event to which the prediction related.

After single prediction rewards calculator 260 determines the ARA, single prediction rewards calculator 260 determines the specific amounts to award to the content-creating user and the feedback-providing users related to the prediction-object. In the example of FIG. 5, single prediction rewards calculator 260 calculates the specific values of SPR₅₀₀, SPR₅₀₅, SPR₅₁₀, and SPR₅₁₅, with the sum of those values equaling the ARA.

In some embodiments, due to being the content-creating user, user 500 is rewarded a higher percentage of the ARA than any of feedback-providing users 505, 510, and 515 are each individually rewarded. This can be done in order to incentivize the creation of content for social networking system 110.

In certain embodiments, the portion of the ARA allocated to the feedback-providing users 505, 510, and 515 is divided amongst users 505, 510, and 515 based on the respective times those users provided feedback regarding prediction-post 520. For example, if user 505 provided feedback first, user 510 provided feedback second, and user 515 third, then user 505 may receive 50% of the portion of the ARA allocated for feedback-providing users, user 510 may receive 30% of the portion of the ARA allocated for feedback-providing users, and user 515 may receive 20% of the portion of the ARA allocated for feedback-providing users. Other distribution breakdowns among feedback-providing users are possible that are consistent with these embodiments. These embodiments are meant to incentivize users to identify quality content that other users have not reviewed yet, and thereby bring that content to the attention of other users.

In some embodiments, users that provide feedback regarding prediction-post 520 prior to a certain period of time elapsing from the time indicated on the time stamp included in prediction-post 520 receive fewer rewards than those users would have if they had waited for that period of time to elapse. These embodiments discourage the use of automated bots that exploit the reward system by automatically providing feedback regarding a prediction-post soon after the prediction-post becomes available for users to review. If not discouraged, such exploits can result in automated bots siphoning off rewards that should go to legitimate users, and thereby resulting in legitimate users having less incentive to participate on social networking system 110.

In certain embodiments, a user may not provide approval feedback regarding multiple prediction-posts that contain the same predicted outcome. This is intended to ensure that a user is not incentivized to provide approval feedback for every prediction-post that contains the predicted outcome, but instead to indicate which prediction-post of those containing the predicted outcome the user deems the best. Such an approach helps reveal what reasoning the user finds most persuasive regarding the predicted outcome as such reasoning is presumably contained in the prediction-post on which the user provides feedback.

In certain embodiments, a user may provide approval feedback regarding multiple prediction-posts that contain the same predicted outcome if the user allocates a portion of their voting power to each of the prediction-posts on which they provide feedback. In such embodiments, the user may not allocate more than 100% of their voting power between all prediction-posts on which they provide feedback.

In some embodiments, a user cannot provide approval feedback for prediction-posts containing conflicting predictions. These embodiments are meant to encourage users to only endorse predictions they believe to be accurate, rather than hedging in an effort to get more rewards if the prediction they believe to be accurate is incorrect.

In some embodiments, users that provide disapproval feedback regarding a prediction-post are not eligible for any rewards related to the prediction-post. These embodiments are beneficial at least in order to ensure that users are not incentivized to simply provide disapproval feedback, but to instead share their own predictions and supporting reasoning with the other users of social networking system 110. In addition, these embodiments are beneficial at least for incentivizing users to provide approval feedback rather than disapproval feedback.

In the example of FIG. 5, after single prediction rewards calculator 260 determines the specific amounts to award users 500, 505, 510, and 515, single prediction rewards calculator 260 updates the users' respective rewards balances in user rewards store 265.

FIG. 6 is a flow chart illustrating a method 600 for rewarding one or more users in a social networking system 110, in accordance with some embodiments. It should be noted that method 600 is only exemplary and should not be construed in a limiting fashion. For example, additional and/or substitute steps to those illustrated may be practiced within the scope of the present invention and in one or more embodiments one or more steps to those illustrated may be omitted or modified. Similarly, the steps may be performed in a different order from that illustrated in FIG. 6, as is reasonable and desired.

The method 600 begins with receiving 605 a predicted outcome regarding an event, series of events, or portion of an event, from a content-creating user, and receiving 610 supporting reasoning from the content-creating user. The supporting reasoning may be, in certain embodiments, freeform-content composed by the content-creating user. In some embodiments, social networking system 110 receives supporting reasoning in the form of the content-creating user's selection from a pre-populated data set.

Feedback regarding the predicted outcome and the supporting reasoning is received 615 from one or more feedback-providing users. In some embodiments, this feedback is provided by each feedback-providing user in the form of a vote regarding a prediction-post that comprises the predicted outcome and the supporting reasoning.

After feedback is received from one or more feedback-providing users, a maximum available rewards (“MAR”) value is calculated 620 based on the feedback. In order for feedback to be taken into account in the MAR calculation, such feedback must have been received by social networking system 110 prior to the start of the event, series of events, or portion of an event, that is the subject of the predicted outcome. In certain embodiments, a MAR is calculated as described above in relation to FIG. 5. In some embodiments, the step of a MAR being calculated 620 based on the feedback comprises utilizing the feedback-providing users' relevant voting power metrics. In certain of these embodiments, each feedback-providing user will have a voting power metric calculated specifically for them consistent with one or more of the embodiments disclosed in conjunction with FIGS. 3 and 4. In some embodiments, each feedback-providing user will have an identical impact on the MAR calculation.

After the occurrence of the event, series of events, or portion of an event, that is the subject of the predicted outcome, the outcome of such event, series of events, or portion of an event, is determined 625. An aggregate reward amount (“ARA”) value is then calculated 630 based on the MAR and the outcome of the relevant event, series of events, or portion of an event. For example, in some embodiments, an ARA is calculated as described above in relation to FIG. 5. In certain embodiments, if the predicted outcome occurs, the ARA equals the MAR, and if the predicted outcome does not occur, the ARA equals the MAR multiplied by the expected probability of the predicted outcome not occurring.

After the ARA is calculated 630, a specific reward amount for the content-creating user is calculated 635 based on the ARA. In addition, specific reward amounts for the feedback-providing users are calculated 640 based on the ARA. In some embodiments, the specific reward amounts for the content-creating user and feedback-providing users are calculated as described above in relation to FIG. 5.

Once specific reward amounts are calculated for the content-creating user and the feedback-providing users, the token balance of each user receiving a reward is updated 645 to reflect how many tokens each user won.

FIG. 7 is a block diagram illustrating a method for determining one or more reward amounts to award one or more users of a social networking system 110, according to some embodiments. FIG. 7 includes the aspects described above in relation to FIG. 5, as well as aspects related to a jackpot prize pool. For example, user 700 corresponds to user 500, user 705 corresponds to user 505, user 710 corresponds to user 510, user 715 corresponds to user 515, prediction-post object 720 corresponds to prediction-post object 520, F₇₀₅ corresponds to F₅₀₅, F₇₁₀ corresponds to F₅₁₀, F₇₁₅ corresponds to F₅₁₅, VPM₇₀₅ corresponds to VPM₅₀₅, VPM₇₁₀ corresponds to VPM₅₁₀, VPM₇₁₅ corresponds to VPM₅₁₅, SPR₇₀₅ corresponds to SPR₅₀₅, SPR₇₁₀ corresponds to SPR₅₁₀, and SPR₇₁₅ corresponds to SPR₅₁₅. In addition, voting power store 240, event store 245, user prediction logger 249, user prediction store 250, user prediction grader 255, and single prediction rewards calculator 260, include the same functionality in FIG. 7 as they do in FIG. 5.

In the example of FIG. 7, single prediction rewards calculator 260 updates jackpot rewards store 275 to reflect that any portion of the MAR that is not awarded to users 700, 705, 710, and 715 is added to a jackpot prize pool.

A jackpot prize pool is a set of tokens from which users may be awarded for completing one or more goals involving multiple accurate predictions. A jackpot prize pool encourages users to accurately predict outcomes when composing, or providing feedback on, prediction-posts. In one aspect, such encouragement is helpful in order to counteract the incentive a user has to predict outcomes with low expected-probabilities of occurring. Such incentive exists because predicting outcomes with low expected-probabilities of occurring minimizes the percentage of a prediction-post's associated MAR that may potentially be lost due to an inaccurate prediction—i.e. predicting low-likelihood outcomes minimizes the difference between a prediction-post's MAR and LAR.

Multiple predictions rewards calculator 270 calculates how many tokens to award a user for completing one or more goals involving multiple predictions. In the example of FIG. 7, multiple predictions rewards calculator 270 accesses information regarding the prediction histories of users 700, 705, 710, and 715 from user prediction store 250 in order to determine whether any of those users completed any goals related to multiple predictions.

If multiple predictions rewards calculator 270 determines that a user completed any goals related to multiple predictions, multiple predictions rewards calculator 270 then calculates the amount of tokens to award the user. Multiple prediction rewards calculator 270 updates the user's token balance in user rewards store 265. In embodiments in which a user's award for accomplishing a multiple-predictions goal is funded by a jackpot prize pool, multiple predictions rewards calculator 270 also updates the balance of jackpot rewards store 275 to reflect the amount the jackpot prize pool is drawn down.

Multiple predictions rewards calculator 270 may award users for completing different goals in different embodiments. For example, in some embodiments, multiple predictions rewards calculator 270 may award a user for accurately predicting the outcomes of a certain number of events, series of events, or portions of events, in a row. For example, a user may be awarded for correctly predicting the outcomes of five, ten, and/or twenty events in a row. In some of these embodiments, the longer a streak a user achieves, the more rewards the user is awarded. For example, a user may be awarded more rewards for correctly predicting twenty events in a row than for correctly predicting five events in a row.

In some embodiments, multiple predictions rewards calculator 270 may award a user for correctly predicting the outcomes of some threshold percentage of events, series of events, or portions of events, they made predictions about. In these embodiments, multiple predictions rewards calculator 270 will only award a user for achieving such a goal after the user composes and/or provides feedback on a certain number of prediction-posts. For example, a user may be awarded for correctly predicting the outcomes of 50% of the events they made predictions about if the user composed and/or provided feedback on at least ten prediction-posts. Requiring a user to compose and/or provide feedback on a certain number of prediction-posts stimulates continued activity by a user that has correctly predicted a threshold percentage of events, series of events, or portions of events, and does not want to jeopardize their accuracy percentage by predicting additional outcomes.

Another example of a goal for which multiple predictions rewards calculator 270 may award a user requires evaluating the aggregate ARAs and MARs of relevant prediction-posts on which the user composed and/or provided feedback. In particular, the ARAs of the prediction-posts are summed, and the MARs of the prediction-posts are summed. If the ratio of the summed ARAs relative to the summed MARs is above a threshold value, then multiple predictions rewards calculator 270 may award the user. In these embodiments, multiple predictions rewards calculator 270 will only award a user for achieving such a goal after the user composes and/or provides feedback on a threshold number of predictions. This strategy can be used in order to stimulate continued activity by a user that has a qualifying ARA-to-MAR ratio and does not want to jeopardize that ratio with additional predictions.

The ARA-to-MAR ratio reward method detailed above is a way to determine when a user would have achieved an ROI above a certain threshold level if that user had risked money and made the relevant predictions on a prediction market. In essence, the ARA-to-MAR ratio reward method detailed above is meant to award users for achieving a certain level of prediction success relative to the before-the-fact expected probabilities of the predicted outcomes occurring. Those of skill in the art will appreciate that there may be other methods for determining when a user has made predictions that would have yielded an ROI above a certain threshold level if that user had made the relevant predictions on a prediction market.

In some embodiments, multiple predictions rewards calculator 270 may award a user for correctly predicting the outcomes of multiple events, series of events, or portions of events, in a row so as to achieve an analog to pre-defined parlay odds. Traditionally, a parlay is a series of two or more bets set up in advance so that the original stake plus its winnings are risked on the successive wagers. According to the embodiments disclosed in this paragraph, the analog to parlay odds can be calculated by multiplying the odds related to all of the relevant events, series of events, or portions of events for which a user correctly predicted the outcomes in a row.

Upon determining that a user has accomplished a goal involving multiple predictions, multiple predictions rewards calculator 270 calculates the amount of rewards to award the user for accomplishing the goal, and then updates the user's token balance in user rewards store 265. In embodiments in which a user's award for accomplishing a multiple-predictions goal is funded by a jackpot prize pool, multiple predictions rewards calculator 270 also updates the balance of jackpot rewards store 275 to reflect the amount the jackpot prize pool is drawn down.

In some embodiments, multiple predictions rewards calculator 270 calculates an amount of rewards based on a goal having a fixed amount of rewards associated with accomplishing it. For example, achieving a goal of correctly predicting the outcomes of five events in a row may always result in an award of 100 tokens to the user that accomplished the goal. In certain of these embodiments, the more difficult a goal is to achieve, the more rewards that are associated with accomplishing it.

In some embodiments, multiple predictions rewards calculator 270 calculates an amount of tokens to award based, at least in part, on the value of a jackpot prize pool, the balance of which is tracked in jackpot rewards store 275. This approach is beneficial if the value of the relevant jackpot prize pool may vary, for example such as when the number of tokens issued within social networking system 110 during each period of time is pre-defined, but the amount of tokens awarded by single predictions rewards calculator 260 during each time period is not pre-defined. As the amount of tokens awarded by single predictions rewards calculator 260 impacts the value of the relevant jackpot prize pool, the number of tokens awarded for accomplishing a multiple-predictions goal must also vary.

In some embodiments, a user that accomplishes a multiple-predictions goal is awarded a pre-defined percent of a jackpot prize pool. In certain of these embodiments, multiple predictions rewards calculator 270 calculates a user's award for accomplishing a multiple-predictions goal, updates jackpot rewards store 275 to reflect the amount of tokens the relevant jackpot prize pool was drawn down, and only after the jackpot prize pool balance is updated will multiple predictions rewards calculator 270 calculate how many tokens to award the next user that accomplishes a multiple-predictions goal. In other words, in these embodiments, multiple predictions rewards calculator 270 calculates awards sequentially. Awarding users sequentially is beneficial when each goal accomplishment results in a pre-defined percent of a jackpot prize pool being awarded because this approach ensures that social networking system 110 is always able to award users for accomplishing multiple-predictions goals, even if users accomplish those goals at an unpredictable rate. Sequential awards in this context also allow the addition of goals to social networking system 110 without modifying the pre-defined award percentages associated with goals that were included previously. In some embodiments in which awards are calculated sequentially, if multiple users accomplish multiple-predictions goals simultaneously (for example because they each accomplished their respective multiple-predictions goals based on the same prediction), multiple predictions rewards calculator 270 will calculate the users' respective awards in the order in which the users made their predictions. In the example of FIG. 7, this means that if the value of the relevant jackpot prize pool is 100 tokens, and users 700 and 705 simultaneously accomplish a multiple-predictions goal worth 10% of the prize pool, but user 700 made his prediction first because he is the content-creating user and user 705 is a feedback-providing user, user 700 would be awarded 10 tokens, those 10 tokens would be deducted from the jackpot prize pool, and user 705 would receive 9 tokens, which is 10% of the 90 remaining tokens in the jackpot prize pool.

In certain embodiments, each multiple-predictions goal recognized within social networking system 110 has a pre-defined weight, and multiple predictions rewards calculator 270 calculates an amount of tokens for achieving a multiple-predictions goal based, at least in part, on that goal's weight. In some of these embodiments, multiple predictions rewards calculator 270 calculates how many tokens from a jackpot prize pool to award a user for achieving a goal based on the following formula: Reward for accomplishing Goal A=W*X*Y/Z

In the above formula, ‘A’ is the relevant multiple-prediction goal's identifying value, ‘W’ is the value of the jackpot prize pool, ‘X’ is the pre-defined percentage of the jackpot prize pool that is to be awarded during the relevant time period, and ‘Y’ is the pre-defined weight of Goal A. In addition, ‘Z’ is the sum of the weights of all of the goals that were accomplished during the relevant time period; in other words, Z=Σᵢ₌₀^{N} Goal i weight*(# of times Goal i accomplished during relevant time period); in this formula, N equals the total number of multiple-predictions goals within social networking system 110.

Awarding users from a jackpot prize pool in this way is beneficial as this approach allows the addition of goals to social networking system 110 without modifying the weights of any goals that were included previously. In addition, this approach ensures that social networking system 110 is always able to award users for accomplishing multiple-predictions goals, even if users accomplish those goals at an unpredictable rate.

In some embodiments in which social networking system 110 does not create a pre-defined number of tokens, multiple predictions rewards calculator 270 calculates an amount of tokens to award a user for accomplishing a multiple-predictions goal based on each multiple-predictions goal being associated with a specific amount of tokens that are awarded when the goal is accomplished.

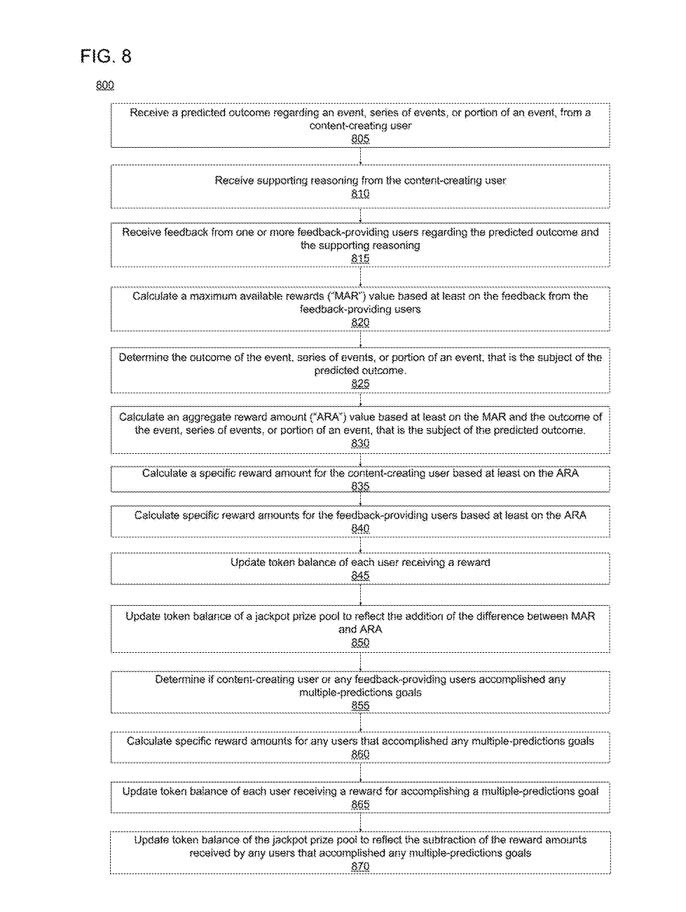

FIG. 8 is a flow chart illustrating a method 800 for rewarding one or more users in a social networking system 110, in accordance with some embodiments. FIG. 8 includes the steps described above in relation to FIG. 6, as well as steps related to awarding one or more users of social networking system 110 for accomplishing goals related to multiple predictions.

It should be noted that method 800 is only exemplary and should not be construed in a limiting fashion. For example, additional and/or substitute steps to those illustrated may be practiced within the scope of the present invention and in one or more embodiments one or more steps to those illustrated may be omitted or modified. Similarly, the steps may be performed in a different order from that illustrated in FIG. 8, as is reasonable and desired.

The method 800 begins with receiving 805 a predicted outcome regarding an event, series of events, or portion of an event, from a content-creating user, and receiving 810 supporting reasoning from the content-creating user. The supporting reasoning may be, in certain embodiments, freeform-content composed by the content-creating user. In some embodiments, social networking system 110 receives supporting reasoning in the form of the content-creating user's selection from a pre-populated data set.

Feedback regarding the predicted outcome and the supporting reasoning is received 815 from one or more feedback-providing users. In some embodiments, this feedback is provided by each feedback-providing user in the form of a vote regarding a prediction-post that comprises the predicted outcome and the supporting reasoning.

After feedback is received from one or more feedback-providing users, a maximum available rewards (“MAR”) value is calculated 820 based on the feedback. In order for feedback to be taken into account in the MAR calculation, such feedback must have been received by social networking system 110 prior to the start of the event, series of events, or portion of an event, that is the subject of the predicted outcome. In certain embodiments, a MAR is calculated as described above in relation to FIG. 5. In some embodiments, the step of a MAR being calculated 820 based on the feedback comprises utilizing the feedback-providing users' relevant voting power metrics. In certain of these embodiments, each feedback-providing user will have a voting power metric calculated specifically for them consistent with one or more of the embodiments disclosed in conjunction with FIGS. 3 and 4. In some embodiments, each feedback-providing user will have an identical impact on the MAR calculation.

After the occurrence of the event, series of events, or portion of an event, that is the subject of the predicted outcome, the outcome of such event, series of events, or portion of an event, is determined 825. An aggregate reward amount (“ARA”) value is then calculated 830 based on the MAR and the outcome of the relevant event, series of events, or portion of an event. For example, in some embodiments, an ARA is calculated as described above in relation to FIG. 5. In certain embodiments, if the predicted outcome occurs, the ARA equals the MAR, and if the predicted outcome does not occur, the ARA equals the MAR multiplied by the expected probability of the predicted outcome not occurring.

After the ARA is calculated 830, a specific reward amount for the content-creating user is calculated 835 based on the ARA. In addition, specific reward amounts for the feedback-providing users are calculated 840 based on the ARA. In some embodiments, the specific reward amounts for the content-creating user and feedback-providing users are calculated as described above in relation to FIG. 5.

Once specific reward amounts are calculated for the content-creating user and the feedback-providing users, the token balance of each user receiving a reward is updated 845 to reflect how many tokens each user won.

In addition to the steps previously discussed in relation to FIG. 6, method 800 also includes steps for rewarding users for achievements related to multiple predictions. One of these steps is updating 850 the balance of a jackpot prize pool to reflect the addition of the difference between the MAR and the ARA, as previously disclosed in conjunction with the description FIG. 7. In other words, step 850 involves supplementing a jackpot prize pool with the portion of the relevant MAR that was not awarded to the content-creating user or the feedback-providing users.

Method 800 also involves determining 855 if the content-creating user or any feedback-providing users accomplished any multiple-predictions goals. If any multiple-predictions goals are achieved, specific reward amounts are calculated 860 for any users that accomplished such goals. Examples of multiple-predictions goals, and ways to calculate reward amounts for achieving multiple-predictions goals, are discussed in conjunction with the description of FIG. 7 above. After specific reward amounts are calculated 860 for users that accomplished multiple-predictions goals, the token balance of each user receiving such a reward is updated 865. In addition, the token balance of the jackpot prize pool is updated 870 to reflect the subtraction of the reward amounts received by any users that accomplished any multiple-predictions goals.

In some embodiments, step 850 is performed after step 860. In some embodiments, step 845 and step 865 are combined into one step. In some embodiments, step 850 and step 870 are combined into one step. In embodiments in which a jackpot prize pool is not utilized, step 850 and step 870 are not necessary.

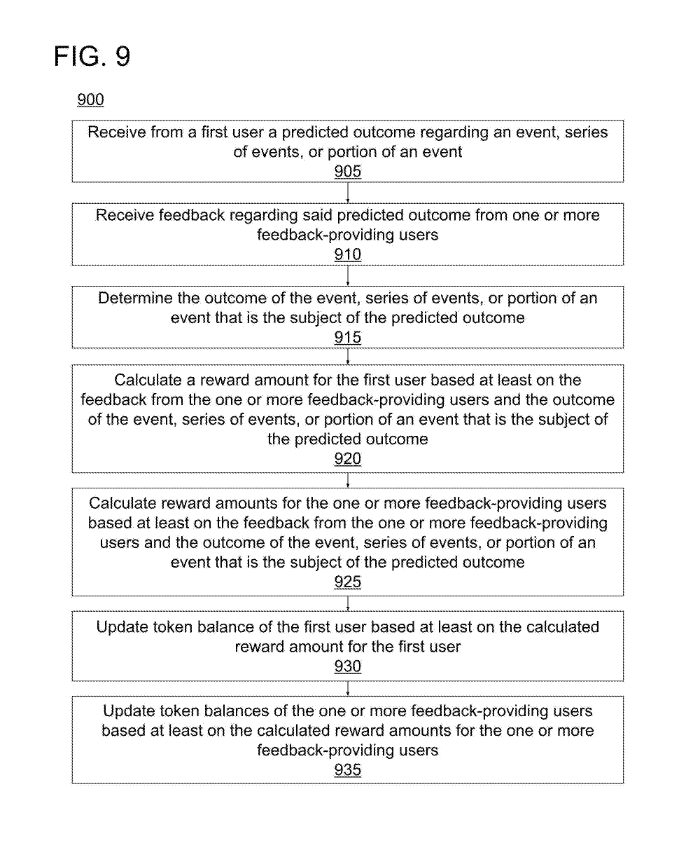

FIG. 9 is a flow chart illustrating a method 900 for rewarding one or more users in a social networking system 110, in accordance with some embodiments. It should be noted that method 900 is only exemplary and should not be construed in a limiting fashion. For example, additional and/or substitute steps to those illustrated may be practiced within the scope of the present invention and in one or more embodiments one or more steps to those illustrated may be omitted or modified. Similarly, the steps may be performed in a different order from that illustrated in FIG. 9, as is reasonable and desired.

Method 900 begins with the social networking system 110 receiving 905 from a first user a predicted outcome regarding an event, series of events, or portion of an event. Next, the social networking system 110 receives 910 from one or more feedback-providing users feedback regarding the first user's predicted outcome. The social networking system 110 then determines 915 the outcome of the event, series of events, or portion of an event that is the subject of the predicted outcome. Next, based at least on the feedback from the one or more feedback-providing users and the outcome of the event, series of events, or portion of an event that is the subject of the predicted outcome, the social networking system 110 calculates 920 a reward amount for the first user and calculates 925 reward amounts for the one or more feedback-providing users. In some embodiments, reward amounts are calculated as described in conjunction with FIGS. 5 and 6. The social networking system 110 then updates 930 the token balance of the first user based on the calculated reward amount for the first user, and also updates 935 the token balances of the one or more feedback-providing users based on the calculated reward amounts for the one or more feedback-providing users.

In some embodiments, the social networking system 110 performs all steps of method 900 except for calculating 925 reward amounts for the one or more feedback-providing users, and updating 935 the token balances of the one or more feedback-providing users based on the calculated reward amounts for the one or more feedback-providing users.

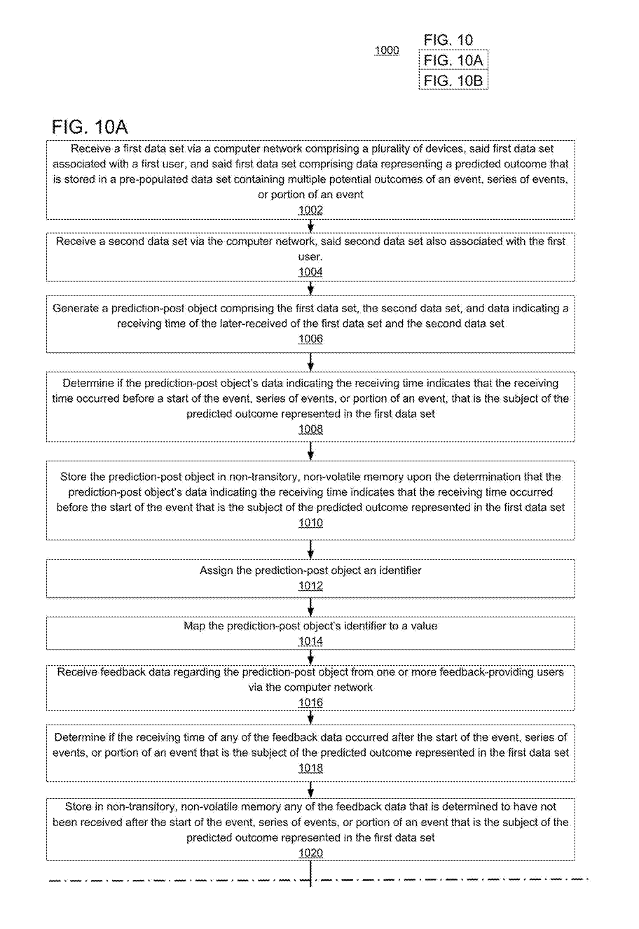

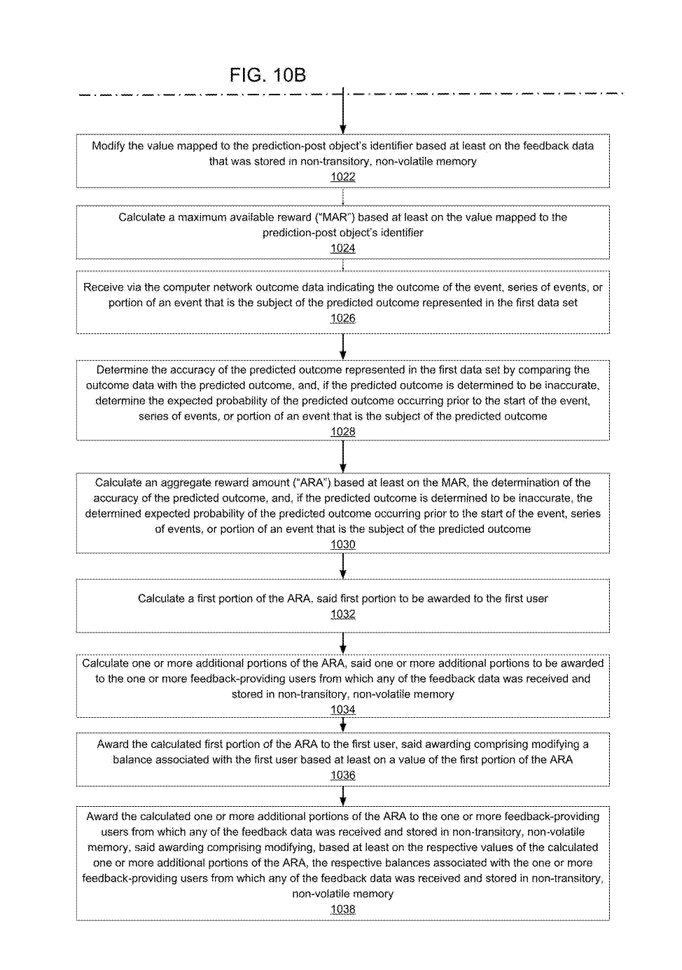

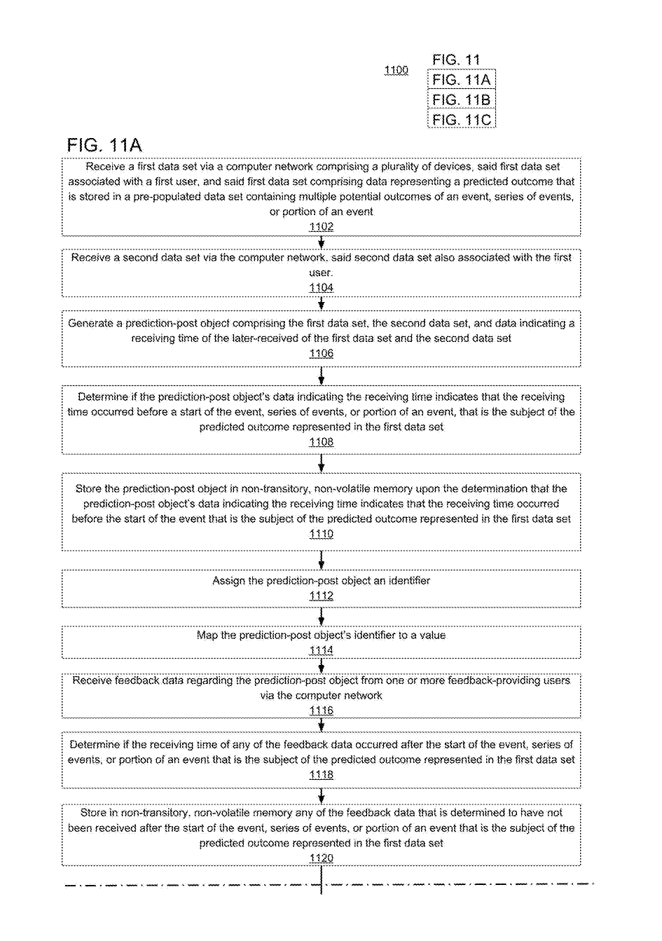

FIG. 10, which consists of FIGS. 10A and 10B, is a flow chart illustrating a method 1000 for rewarding one or more users in a social networking system 110, in accordance with some embodiments. Each of FIGS. 10A and 10B illustrate a sequential portion of the overall method. It should be noted that method 1000 is only exemplary and should not be construed in a limiting fashion. For example, additional and/or substitute steps to those illustrated may be practiced within the scope of the present invention and in one or more embodiments one or more steps to those illustrated may be omitted or modified. Similarly, the steps may be performed in a different order from that illustrated in FIG. 10, as is reasonable and desired.

As depicted in FIG. 10A, social networking system 110 receives 1002 a first data set via a computer comprising a plurality of devices network, said first data set associated with a first user, and said first data set comprising data representing a predicted outcome stored in a pre-populated data set containing potential outcomes of an event, series of events, or portion of an event. In addition, social networking system 110 receives 1004 a second data set via the computer network, said second data set also associated with the first user. In some embodiments, the second data set comprises data representing freeform-content. In some embodiments, the second data set comprises data representing one or more selections from one or more pre-populated data sets, not including the pre-populated data set containing potential outcomes. These one or more pre-populated data sets may, for example, contain possible reasons why a user may believe a particular potential outcome relating to an event, a series of events, or a portion of an event will occur.

After receiving the first data set and the second data set, social networking system 110 generates 1006 a prediction-post object comprising the first data set, the second data set, and data indicating a receiving time of the later-received of the first data set and the second data set. Social networking system 110 then determines 1008 if the prediction-post object's data indicating the receiving time indicates that the receiving time occurred before a start of the event, series of events, or portion of an event, that is the subject of the predicted outcome represented in the first data set. Upon determining that the prediction-post object's data indicating the receiving time indicates that the receiving time occurred before the start of the event that is the subject of the predicted outcome represented in the first data set, social networking system 110 stores 1010 the prediction-post object in non-transitory, non-volatile memory.

The prediction-post object is assigned 1012 an identifier. This identifier may be, for example, a key of a key-value pair in a dictionary or hash table. The prediction-object's identifier is then mapped 1014 to a value. In some embodiments, this value is zero.

Social networking system 110 receives 1016 feedback data regarding the prediction-post object from one or more feedback-providing users via the computer network. Social networking system 110 determines 1018 if the receiving time of any of the feedback data occurred after the start of the event, series of events, or portion of an event that is the subject of the predicted outcome represented in the first data set. In some embodiments, this determination 1018 may be performed by comparing the relevant receiving times to information stored in event store 245 regarding the relevant start of the event, series of events, or portion of an event. Any of the feedback data that is determined to have not been received after the start of the event, series of events, or portion of an event that is the subject of the predicted outcome represented in the first data set, is then stored 1020 in non-transitory, non-volatile memory. In certain embodiments, such feedback data is stored in user prediction store 250.

As shown in FIG. 10B, based at least on the feedback data that was stored in non-transitory, non-volatile memory, the value mapped to the prediction-post object's identifier is modified 1022. In some embodiments, the value mapped to the prediction-post object's identifier is incremented by 1 for each user that provided feedback data that was stored in non-transitory, non-volatile memory. In some embodiments, the value is modified 1022 based on utilizing the feedback data to determine each feedback-providing user's relevant voting power metric and combining those voting power metrics, as disclosed previously in conjunction with the discussion of FIGS. 5 and/or 6. In certain of these embodiments, each relevant voting power metric accounts for the accuracy of any predictions the relevant user made regarding prior events, series of events, or portions of events, of the same type as the event, series of events, or portion of an event, that is the subject of the predicted outcome represented in the first data set.

Based at least on the value mapped to the prediction-post object's identifier, social networking system 110 calculates 1024 a maximum available reward (“MAR”). In some embodiments, this calculation is performed in a manner disclosed previously in conjunction with the discussion of FIGS. 5 and/or 6.

Social networking system 110 receives 1026 via the computer network outcome data indicating the outcome of the event, series of events, or portion of an event that is the subject of the predicted outcome represented in the first data set. The accuracy of the predicted outcome represented in the first data set is then determined 1028 by comparing the outcome data with the predicted outcome, and, if the predicted outcome is determined to be inaccurate, social networking system 110 determines the expected probability of the predicted outcome occurring prior to the start of the event, series of events, or portion of an event that is the subject of the predicted outcome. In some embodiments, the expected probability of the predicted outcome occurring may be determined by utilizing odds information from a sportsbook. In some embodiments, the expected probability of the predicted outcome occurring may be determined by utilizing odds information from a prediction market. In some embodiments, the expected probability of the predicted outcome occurring may be determined by utilizing pricing information from a investment brokerage. In some embodiments, the expected probability of the predicted outcome occurring may be determined by utilizing information relating to the potential return on investment (“ROI”) that can be expected by betting and/or investing based on that potential outcome occurring or not occurring, for example as described in conjunction with the discussion of FIG. 5.

Social networking system 110 calculates 1030 an aggregate reward amount (“ARA”) based on at least the MAR, the determination of the accuracy of the predicted outcome, and, if the predicted outcome is determined to be inaccurate, the determined expected probability of the predicted outcome occurring prior to the start of the event, series of events, or portion of an event that is the subject of the predicted outcome. In some embodiments, the ARA is calculated in a manner described in conjunction with the discussion of FIGS. 5 and/or 6.

A first portion of the ARA is calculated 1032, with this first portion to be awarded to the first user. In addition, one or more additional portions of the ARA are calculated 1034, with these one or more additional portions to be awarded to the one or more feedback-providing users from which any of the feedback data was received and stored in non-transitory, non-volatile memory. In some embodiments, the first portion of the ARA, and the one or more additional portions of the ARA, are calculated in a manner described in conjunction with the discussion of FIGS. 5 and/or 6.

Social networking system 110 awards 1036 the calculated first portion of the ARA to the first user. This awarding 1036 comprises modifying a balance associated with the first user based at least on the value of the first portion of the ARA. In addition, social networking system 110 awards 1038 the calculated one or more additional portions of the ARA to the one or more feedback-providing users from which any of the feedback data was received and stored in non-transitory, non-volatile memory. This awarding 1038 comprises modifying, based at least on the respective values of the calculated one or more additional portions of the ARA, the respective balances associated with the one or more feedback-providing users from which any of the feedback data was received and stored in non-transitory, non-volatile memory.

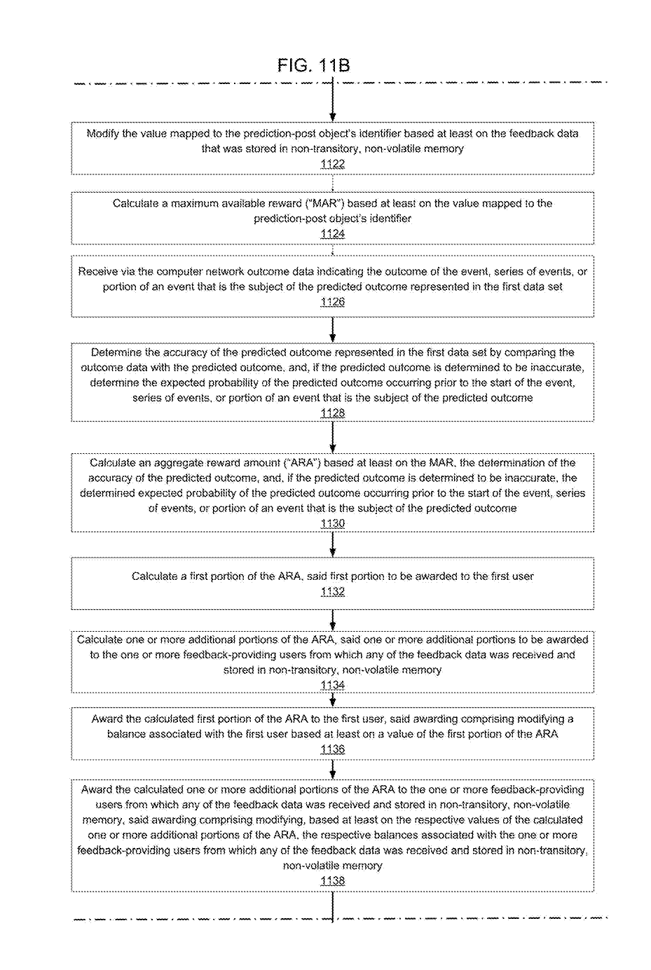

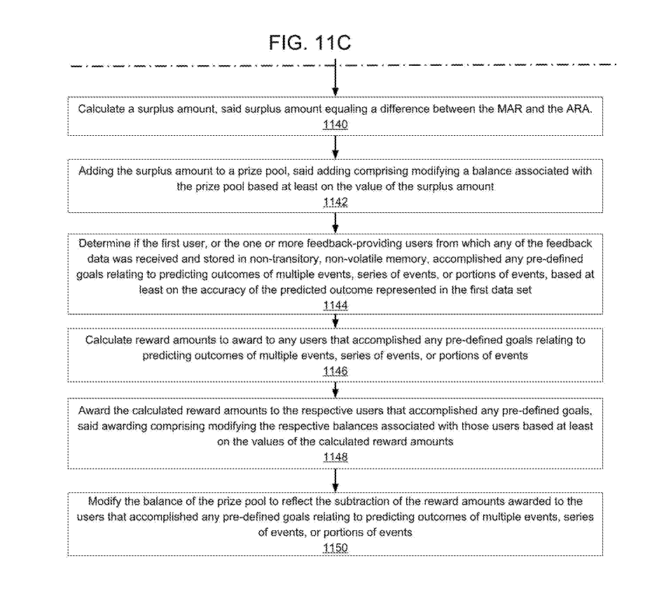

FIG. 11, which consists of FIGS. 11A, 11B, and 11C, is a flow chart illustrating a method 1100 for rewarding one or more users in a social networking system 110, in accordance with some embodiments. Each of FIGS. 11A, 11B, and 11C illustrate a sequential portion of the overall method. FIG. 11 includes the steps described above in relation to FIG. 10, as well as steps related to awarding one or more users of social networking system 110 for accomplishing goals related to multiple predictions. It should be noted that method 1100 is only exemplary and should not be construed in a limiting fashion. For example, additional and/or substitute steps to those illustrated may be practiced within the scope of the present invention and in one or more embodiments one or more steps to those illustrated may be omitted or modified. Similarly, the steps may be performed in a different order from that illustrated in FIG. 11, as is reasonable and desired.

As depicted in FIG. 11A, social networking system 110 receives 1102 a first data set via a computer network comprising a plurality of devices, said first data set associated with a first user, and said first data set comprising data representing a predicted outcome stored in a pre-populated data set containing potential outcomes of an event, series of events, or portion of an event. In addition, social networking system 110 receives 1104 a second data set via the computer network, said second data set also associated with the first user. In some embodiments, the second data set comprises data representing freeform-content. In some embodiments, the second data set comprises data representing one or more selections from one or more pre-populated data sets, not including the pre-populated data set containing potential outcomes. These one or more pre-populated data sets may, for example, contain possible reasons why a user may believe a particular potential outcome relating to an event, a series of events, or a portion of an event will occur.

After receiving the first data set and the second data set, social networking system 110 generates 1106 a prediction-post object comprising the first data set, the second data set, and data indicating a receiving time of the later-received of the first data set and the second data set. Social networking system 110 then determines 1108 if the prediction-post object's data indicating the receiving time indicates that the receiving time occurred before a start of the event, series of events, or portion of an event, that is the subject of the predicted outcome represented in the first data set. Upon determining that the prediction-post object's data indicating the receiving time indicates that the receiving time occurred before the start of the event that is the subject of the predicted outcome represented in the first data set, social networking system 110 stores 1110 the prediction-post object in non-transitory, non-volatile memory.

The prediction-post object is assigned 1112 an identifier. This identifier may be, for example, a key of a key-value pair in a dictionary or hash table. The prediction-object's identifier is then mapped 1114 to a value. In some embodiments, this value is 0.

Social networking system 110 receives 1116 feedback data regarding the prediction-post object from one or more feedback-providing users via the computer network. Social networking system 110 determines 1118 if the receiving time of any of the feedback data occurred after the start of the event, series of events, or portion of an event that is the subject of the predicted outcome represented in the first data set. In some embodiments, this determination 1118 may be performed by comparing the relevant receiving times to information stored in event store 245 regarding the relevant start of the event, series of events, or portion of an event. Any of the feedback data that is determined to have not been received after the start of the event, series of events, or portion of an event that is the subject of the predicted outcome represented in the first data set, is then stored 1120 in non-transitory, non-volatile memory. In certain embodiments, such feedback data is stored in user prediction store 250.

As shown in FIG. 11B, based at least on the feedback data that was stored in non-transitory, non-volatile memory, the value mapped to the prediction-post object's identifier is modified 1122. In some embodiments, the value mapped to the prediction-post object's identifier is incremented by 1 for each user that provided feedback data that was stored in non-transitory, non-volatile memory. In some embodiments, the value is modified 1122 based on utilizing the feedback data to determine each feedback-providing user's relevant voting power metric and combining those voting power metrics, as disclosed previously in conjunction with the discussion of FIGS. 5 and/or 6. In certain of these embodiments, each relevant voting power metric accounts for the accuracy of any predictions the relevant user made regarding prior events, series of events, or portions of events, of the same type as the event, series of events, or portion of an event, that is the subject of the predicted outcome represented in the first data set.

Based at least on the value mapped to the prediction-post object's identifier, social networking system 110 calculates 1124 a maximum available reward (“MAR”). In some embodiments, this calculation is performed in a manner disclosed previously in conjunction with the discussion of FIGS. 5 and/or 6.

Social networking system 110 receives 1126 via the computer network outcome data indicating the outcome of the event, series of events, or portion of an event that is the subject of the predicted outcome represented in the first data set. The accuracy of the predicted outcome represented in the first data set is then determined 1128 by comparing the outcome data with the predicted outcome, and, if the predicted outcome is determined to be inaccurate, social networking system 110 determines an expected probability of the predicted outcome occurring prior to the start of the event, series of events, or portion of an event that is the subject of the predicted outcome. In some embodiments, the expected probability of the predicted outcome occurring may be calculated by utilizing odds information from a sportsbook. In some embodiments, the expected probability of the predicted outcome occurring may be calculated by utilizing odds information from a prediction market. In some embodiments, the expected probability of the predicted outcome occurring may be calculated by utilizing pricing information from a investment brokerage. In some embodiments, the expected probability of the predicted outcome occurring may be calculated by utilizing information relating to the potential return on investment (“ROI”) that can be expected by betting and/or investing based on that potential outcome occurring or not occurring, for example as described in conjunction with the discussion of FIG. 5.

Social networking system 110 calculates 1130 an aggregate reward amount (“ARA”) based on at least the MAR, the determination of the accuracy of the predicted outcome, and, if the predicted outcome is determined to be inaccurate, the determined expected probability of the predicted outcome occurring prior to the start of the event, series of events, or portion of an event that is the subject of the predicted outcome. In some embodiments, the ARA is calculated in a manner described in conjunction with the discussion of FIGS. 5 and/or 6.

A first portion of the ARA is calculated 1132, with this first portion to be awarded to the first user. In addition, one or more additional portions of the ARA are calculated 1134, with these one or more additional portions to be awarded to the one or more feedback-providing users from which any of the feedback data was received and stored in non-transitory, non-volatile memory. In some embodiments, the first portion of the ARA, and the one or more additional portions of the ARA, are calculated in a manner described in conjunction with the discussion of FIGS. 5 and/or 6.

Social networking system 110 awards 1136 the calculated first portion of the ARA to the first user. This awarding 1136 comprises modifying a balance associated with the first user based at least on the value of the first portion of the ARA. In addition, social networking system 110 awards 1138 the calculated one or more additional portions of the ARA to the one or more feedback-providing users from which any of the feedback data was received and stored in non-transitory, non-volatile memory. This awarding 1138 comprises modifying, based at least on the respective values of the calculated one or more additional portions of the ARA, the respective balances associated with the one or more feedback-providing users from which any of the feedback data was received and stored in non-transitory, non-volatile memory.

As depicted in FIG. 11C, social networking system 110 calculates 1140 a surplus amount that equals a difference between the MAR and the ARA. This surplus amount is added 1142 to a prize pool, with the adding comprising modifying a balance associated with the prize pool based at least on the value of the surplus amount.

Based at least on the accuracy of the predicted outcome represented in the first data set, social networking system 110 determines 1144 if the first user, or the one or more feedback-providing users from which any of the feedback data was received and stored in non-transitory, non-volatile memory, accomplished any pre-defined goals relating to predicting outcomes of multiple events, series of events, or portions of events. Reward amounts to award to any users that accomplished any pre-defined goals relating to predicting outcomes of multiple events, series of events, or portions of events, are then calculated 1146.

Social networking system 110 awards 1148 the calculated reward amounts to the respective users that accomplished any pre-defined goals, with the awarding 1148 comprising modifying the respective balances associated with those users based at least on the values of the calculated reward amounts. In addition, social networking system 110 modifies 1150 the balance of the prize pool to reflect the subtraction of the reward amounts awarded to the users that accomplished any pre-defined goals relating to predicting outcomes of multiple events, series of events, or portions of events.

In certain embodiments, a prize pool is not utilized. In these embodiments, step 1142 and step 1150 are not necessary.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, non-volatile, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, non-volatile, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2017, UnVig, LLC.

1. A method for rewarding users of a social network, comprising:
receiving a first data set via a computer network comprising a plurality of devices, said first data set associated with a first user, and said first data set comprising data representing a predicted outcome that is stored in a pre-populated data set containing multiple potential outcomes of an event, series of events, or portion of an event;
receiving a second data set via the computer network, said second data set also associated with the first user;
generating a prediction-post object comprising the first data set, the second data set, and data indicating a receiving time of the later-received of the first data set and the second data set;
determining if the prediction-post object's data indicating the receiving time indicates that the receiving time occurred before a start of the event, series of events, or portion of an event, that is the subject of the predicted outcome represented in the first data set;
storing the prediction-post object in non-transitory, non-volatile memory upon the determination that the prediction-post object's data indicating the receiving time indicates that the receiving time occurred before the start of the event that is the subject of the predicted outcome represented in the first data set;
assigning the prediction-post object an identifier;
mapping the prediction-post object's identifier to a value;
receiving feedback data regarding the prediction-post object from one or more feedback-providing users via the computer network;
determining if the receiving time of any of the feedback data occurred after the start of the event, series of events, or portion of an event that is the subject of the predicted outcome represented in the first data set;
storing in non-transitory, non-volatile memory any of the feedback data that is determined to have not been received after the start of the event, series of events, or portion of an event that is the subject of the predicted outcome represented in the first data set;
modifying the value mapped to the prediction-post object's identifier based at least on the feedback data that was stored in non-transitory, non-volatile memory;
calculating a maximum available reward (“MAR”) based at least on the value mapped to the prediction-post object's identifier;
receiving via the computer network outcome data indicating the outcome of the event, series of events, or portion of an event that is the subject of the predicted outcome represented in the first data set;
determining the accuracy of the predicted outcome represented in the first data set by comparing the outcome data with the predicted outcome, and, if the predicted outcome is determined to be inaccurate, determining the expected probability of the predicted outcome occurring prior to the start of the event, series of events, or portion of an event that is the subject of the predicted outcome;
calculating an aggregate reward amount (“ARA”) based at least on the MAR, the determination of the accuracy of the predicted outcome, and, if the predicted outcome is determined to be inaccurate, the determined expected probability of the predicted outcome occurring prior to the start of the event, series of events, or portion of an event that is the subject of the predicted outcome;
calculating a first portion of the ARA, said first portion to be awarded to the first user;
calculating one or more additional portions of the ARA, said one or more additional portions to be awarded to the one or more feedback-providing users from which any of the feedback data was received and stored in non-transitory, non-volatile memory;
awarding the calculated first portion of the ARA to the first user, said awarding comprising modifying a balance associated with the first user based at least on a value of the first portion of the ARA; and
awarding the calculated one or more additional portions of the ARA to the one or more feedback-providing users from which any of the feedback data was received and stored in non-transitory, non-volatile memory, said awarding comprising modifying, based at least on the respective values of the calculated one or more additional portions of the ARA, the respective balances associated with the one or more feedback-providing users from which any of the feedback data was received and stored in non-transitory, non-volatile memory.

2. The method of claim 1, further comprising:
calculating a surplus amount, said surplus amount equaling a difference between the MAR and the ARA;
adding the surplus amount to a prize pool, said adding comprising modifying a balance associated with the prize pool based at least on the value of the surplus amount;
determining if the first user, or the one or more feedback-providing users from which any of the feedback data was received and stored in non-transitory, non-volatile memory, accomplished any pre-defined goals relating to predicting outcomes of multiple events, series of events, or portions of events, based at least on the accuracy of the predicted outcome represented in the first data set;
calculating reward amounts to award to any users that accomplished any pre-defined goals relating to predicting outcomes of multiple events, series of events, or portions of events;
awarding the calculated reward amounts to the respective users that accomplished any pre-defined goals, said awarding comprising modifying the respective balances associated with those users based at least on the values of the calculated reward amounts; and
modifying the balance of the prize pool to reflect the subtraction of the reward amounts awarded to the users that accomplished any pre-defined goals relating to predicting outcomes of multiple events, series of events, or portions of events.

3. The method of claim 1, wherein determining the expected probability of the predicted outcome occurring further comprises calculating an expected probability of the predicted outcome occurring at least utilizing the potential return on investment that could be expected by betting and/or investing based on the predicted outcome occurring.

4. The method of claim 1, wherein modifying the value mapped to the prediction-post object's identifier based at least on the feedback data that was stored in non-transitory, non-volatile memory comprises utilizing the feedback data to determine each feedback-providing user's relevant voting power metric and combining those voting power metrics.

5. The method of claim 4, wherein each relevant voting power metric accounts for the accuracy of any predictions the relevant user made regarding prior events, series of events, or portions of events, of the same type as the event, series of events, or portion of an event, that is the subject of the predicted outcome represented in the first data set.

6. A non-transitory, non-volatile computer-readable medium storing executable instructions thereon, which, when executed by a processor, cause the processor to perform operations including:
receiving a first data set via a computer network comprising a plurality of devices, said first data set associated with a first user, and said first data set comprising data representing a predicted outcome that is stored in a pre-populated data set containing multiple potential outcomes of an event, series of events, or portion of an event;
receiving a second data set via the computer network, said second data set also associated with the first user;
generating a prediction-post object comprising the first data set, the second data set, and data indicating a receiving time of the later-received of the first data set and the second data set;
determining if the prediction-post object's data indicating the receiving time indicates that the receiving time occurred before a start of the event, series of events, or portion of an event, that is the subject of the predicted outcome represented in the first data set;
storing the prediction-post object in non-transitory, non-volatile memory upon the determination that the prediction-post object's data indicating the receiving time indicates that the receiving time occurred before the start of the event that is the subject of the predicted outcome represented in the first data set;
assigning the prediction-post object an identifier;
mapping the prediction-post object's identifier to a value;
receiving feedback data regarding the prediction-post object from one or more feedback-providing users via the computer network;
determining if the receiving time of any of the feedback data occurred after the start of the event, series of events, or portion of an event that is the subject of the predicted outcome represented in the first data set;
storing in non-transitory, non-volatile memory any of the feedback data that is determined to have not been received after the start of the event, series of events, or portion of an event that is the subject of the predicted outcome represented in the first data set;
modifying the value mapped to the prediction-post object's identifier based at least on the feedback data that was stored in non-transitory, non-volatile memory;
calculating a maximum available reward (“MAR”) based at least on the value mapped to the prediction-post object's identifier;
receiving via the computer network outcome data indicating the outcome of the event, series of events, or portion of an event that is the subject of the predicted outcome represented in the first data set;
determining the accuracy of the predicted outcome represented in the first data set by comparing the outcome data with the predicted outcome, and, if the predicted outcome is determined to be inaccurate, determining the expected probability of the predicted outcome occurring prior to the start of the event, series of events, or portion of an event that is the subject of the predicted outcome;
calculating an aggregate reward amount (“ARA”) based at least on the MAR, the determination of the accuracy of the predicted outcome, and, if the predicted outcome is determined to be inaccurate, the determined expected probability of the predicted outcome occurring prior to the start of the event, series of events, or portion of an event that is the subject of the predicted outcome;
calculating a first portion of the ARA, said first portion to be awarded to the first user;
calculating one or more additional portions of the ARA, said one or more additional portions to be awarded to the one or more feedback-providing users from which any of the feedback data was received and stored in non-transitory, non-volatile memory;
awarding the calculated first portion of the ARA to the first user, said awarding comprising modifying a balance associated with the first user based at least on the value of the first portion of the ARA; and
awarding the calculated one or more additional portions of the ARA to the one or more feedback-providing users from which any of the feedback data was received and stored in non-transitory, non-volatile memory, said awarding comprising modifying, based at least on the respective values of the calculated one or more additional portions of the ARA, the respective balances associated with the one or more feedback-providing users from which any of the feedback data was received and stored in non-transitory, non-volatile memory.

7. The non-transitory, non-volatile computer-readable medium of claim 6, wherein the operations further include:
calculating a surplus amount, said surplus amount equaling the difference between the MAR and the ARA;
adding the surplus amount to a prize pool, said adding comprising modifying a balance associated with the prize pool based at least on the value of the surplus amount;
determining if the first user, or the one or more feedback-providing users from which any of the feedback data was received and stored in non-transitory, non-volatile memory, accomplished any pre-defined goals relating to predicting outcomes of multiple events, series of events, or portions of events, based at least on the accuracy of the predicted outcome represented in the first data set;
calculating reward amounts to award to any users that accomplished any pre-defined goals relating to predicting outcomes of multiple events, series of events, or portions of events;
awarding the calculated reward amounts to the respective users that accomplished any pre-defined goals, said awarding comprising modifying the respective balances associated with those users based at least on the values of the calculated reward amounts; and
modifying the balance of the prize pool to reflect the subtraction of the reward amounts awarded to the users that accomplished any pre-defined goals relating to predicting outcomes of multiple events, series of events, or portions of events.

8. The non-transitory, non-volatile computer-readable medium of claim 6, wherein determining the expected probability of the predicted outcome occurring further comprises calculating an expected probability of the predicted outcome occurring at least utilizing the potential return on investment that could be expected by betting and/or investing based on the predicted outcome occurring.

9. The non-transitory, non-volatile computer-readable medium of claim 6, wherein modifying the value mapped to the prediction-post object's identifier based at least on the feedback data that was stored in non-transitory, non-volatile memory comprises utilizing the feedback data to determine each feedback-providing user's relevant voting power metric and combining those voting power metrics.

10. The non-transitory, non-volatile computer-readable medium of claim 9, wherein each relevant voting power metric accounts for the accuracy of any predictions the relevant user made regarding prior events, series of events, or portions of events, of the same type as the event, series of events, or portion of an event, that is the subject of the predicted outcome represented in the first data set.

11. A computer system comprising:
a processor;
a memory device holding an instruction set executable on the processor to cause the computer system to perform operations comprising:
receiving a first data set via a computer network comprising a plurality of devices, said first data set associated with a first user, and said first data set comprising data representing a predicted outcome that is stored in a pre-populated data set containing multiple potential outcomes of an event, series of events, or portion of an event;
receiving a second data set via the computer network, said second data set also associated with the first user;
generating a prediction-post object comprising the first data set, the second data set, and data indicating a receiving time of the later-received of the first data set and the second data set;
determining if the prediction-post object's data indicating the receiving time indicates that the receiving time occurred before a start of the event, series of events, or portion of an event, that is the subject of the predicted outcome represented in the first data set;
storing the prediction-post object in non-transitory, non-volatile memory upon the determination that the prediction-post object's data indicating the receiving time indicates that the receiving time occurred before the start of the event that is the subject of the predicted outcome represented in the first data set;
assigning the prediction-post object an identifier;
mapping the prediction-post object's identifier to a value;
receiving feedback data regarding the prediction-post object from one or more feedback-providing users via the computer network;
determining if the receiving time of any of the feedback data occurred after the start of the event, series of events, or portion of an event that is the subject of the predicted outcome represented in the first data set;
storing in non-transitory, non-volatile memory any of the feedback data that is determined to have not been received after the start of the event, series of events, or portion of an event that is the subject of the predicted outcome represented in the first data set;
modifying the value mapped to the prediction-post object's identifier based at least on the feedback data that was stored in non-transitory, non-volatile memory;
calculating a maximum available reward (“MAR”) based at least on the value mapped to the prediction-post object's identifier;
receiving via the computer network outcome data indicating the outcome of the event, series of events, or portion of an event that is the subject of the predicted outcome represented in the first data set;
determining the accuracy of the predicted outcome represented in the first data set by comparing the outcome data with the predicted outcome, and, if the predicted outcome is determined to be inaccurate, determining the expected probability of the predicted outcome occurring prior to the start of the event, series of events, or portion of an event that is the subject of the predicted outcome;
calculating an aggregate reward amount (“ARA”) based at least on the MAR, the determination of the accuracy of the predicted outcome, and, if the predicted outcome is determined to be inaccurate, the determined expected probability of the predicted outcome occurring prior to the start of the event, series of events, or portion of an event that is the subject of the predicted outcome;
calculating a first portion of the ARA, said first portion to be awarded to the first user;
calculating one or more additional portions of the ARA, said one or more additional portions to be awarded to the one or more feedback-providing users from which any of the feedback data was received and stored in non-transitory, non-volatile memory;
awarding the calculated first portion of the ARA to the first user, said awarding comprising modifying a balance associated with the first user based at least on the value of the first portion of the ARA; and
awarding the calculated one or more additional portions of the ARA to the one or more feedback-providing users from which any of the feedback data was received and stored in non-transitory, non-volatile memory, said awarding comprising modifying, based at least on the respective values of the calculated one or more additional portions of the ARA, the respective balances associated with the one or more feedback-providing users from which any of the feedback data was received and stored in non-transitory, non-volatile memory.

12. The computer system of claim 11, wherein the operations further comprise:
calculating a surplus amount, said surplus amount equaling a difference between the MAR and the ARA;
adding the surplus amount to a prize pool, said adding comprising modifying a balance associated with the prize pool based at least on the value of the surplus amount;
determining if the first user, or the one or more feedback-providing users from which any of the feedback data was received and stored in non-transitory, non-volatile memory, accomplished any pre-defined goals relating to predicting outcomes of multiple events, series of events, or portions of events, based at least on the accuracy of the predicted outcome represented in the first data set;
calculating reward amounts to award to any users that accomplished any pre-defined goals relating to predicting outcomes of multiple events, series of events, or portions of events;
awarding the calculated reward amounts to the respective users that accomplished any pre-defined goals, said awarding comprising modifying the respective balances associated with those users based at least on the values of the calculated reward amounts; and
modifying the balance of the prize pool to reflect the subtraction of the reward amounts awarded to the users that accomplished any pre-defined goals relating to predicting outcomes of multiple events, series of events, or portions of events.

13. The computer system of claim 11, wherein determining the expected probability of the predicted outcome occurring further comprises calculating an expected probability of the predicted outcome occurring at least utilizing the potential return on investment that could be expected by betting and/or investing based on the predicted outcome occurring.

14. The computer system of claim 11, wherein modifying the value mapped to the prediction-post object's identifier based at least on the feedback data that was stored in non-transitory, non-volatile memory comprises utilizing the feedback data to determine each feedback-providing user's relevant voting power metric and combining those voting power metrics.

15. The non-transitory, non-volatile computer-readable medium of claim 14, wherein each relevant voting power metric accounts for the accuracy of any predictions the relevant user made regarding prior events, series of events, or portions of events, of the same type as the event, series of events, or portion of an event, that is the subject of the predicted outcome represented in the first data set.
